(19) United States
(12) Patent Application Publication
(10) Pub. No.: US 2025/0002179 A1
(43) Pub. Date: Jan. 2, 2025

(54) Alternating Angular Momentum Drive-2 (AAMD)

(71) Applicant: Steven Mark Jones, Mason, NH (US)

(72) Inventor: Steven Mark Jones, Mason, NH (US)

(21) Appl. No.: 18/445,309

(22) Filed: Jun. 28, 2023

(51) Int. Cl. B64G 1/40

(52) U.S. Cl. CPC B64G 1/409

(57) ABSTRACT

The AAMD was designed to address the concerns of deep space travel, in both the distance and time required. Today's rocket propulsion systems rely on expelling large amounts of fuel for short intervals and then coasting long intervals. This method is both expensive and time consuming where deep space is concerned.

The AAMD is an alternative to rocket systems and it enables a vehicle to have a constant acceleration rates and deceleration rates. For instance, if the AAMD could provide a constant 1 G of acceleration and 1 G of deceleration, it would take less than a week to go from earth to mars, depending on their locations, whereas today's fastest rockets are 7 to 9 months, for the same trip.

Slow and long travel times also are not good for the human body as the bones and muscle begin to deteriorate. The AAMD with its constant G applied to the occupants, will enjoy an artificial gravity produced by means of the constant acceleration. This would allow the occupants to have no breakdown in bones and muscle.

The system uses of 2 counter rotating rotors and 8—orbital motors/generator per rotor, with—4 gyroscopes per orbital motor/generator. The moveable gyroscopes are capable of altering their location, from the main rotors axis. At the same time enable the other spinning mass to experience a balanced rotor the entire duration of the moveable weights altering their location of mass. The AAMD enables a means to impart linear movement in short increments of instantaneous directional linear thrust and follow the principle of the conservation of angular momentum.

This is achieved and enables the vehicles propulsion system to have a 2 stage “push”-“pull” operation with controllable, directional thrust capability. If there was a need to move an object that is stationary, it is necessary to apply a force to influence it to do so. The AAMD can be powered by a nuclear reactor for extreme long range and ultra-high speeds to reach planets not feasible by means of rockets.

### CROSS-REFERENCE TO RELATED APPLICATIONS

This application is related to and claims priory from Provisional Patent Application Ser.

Application Ser. No. 63/473,857 was filed on Jun. 29, 2022

### REGARDING FEDERALLY SPONSORED RESEARCH OR STATEMENT DEVELOPMENT

“Not Applicable”

### INCORPORATION-BY-REFERENCE OF MATERIAL SUBMITTED ON A COMPACT DISC.

“Not Applicable”

### BACKGROUND OF THE INVENTION

The invention was conceived for the need to enable a spaceship to travel faster than conventional rocket technology today. Conventional rockets expel propellant out the back to produce thrust. This dramatically reduces the range of such system and brought the invention to life. With the invention using enclosed system to produce thrust and not expelling propellant out the back, the operational range of the invention when incorporated into a spaceship is increased substantially.

### BRIEF SUMMARY OF THE INVENTION

The Alternating Angular Momentum Drive (AAMD) is a revolutionary propulsion system with very unique capabilities. The AAMD can provide an internal directional linear thrust system without relying on an external medium to propel the vehicle. This system relies on imparting linear movement by the delivery of a constant directional force to a vehicle by means of internally manipulating centrifugal and gyroscopic forces.

The AAMD has vastly improved capabilities when compared to other propulsion systems today, which opens up new future ideas of space travel. The AAMD can have almost unlimited range in a nuclear reactor powered spaceship or satellite when equipped with radioscopic thermoelectric generators. With this endurance capability opens the door for an entirely new type space exploration.

### BRIEF DESCRIPTION OF THE SEVERAL VIEWS OF THE FIGURES

FIG. 1: Cutaway view of the AAMD, showing its internal components, with the gyroscopes (19-43) in the ‘in position’ closest to the main rotors (15-39) radius and the counter weights (52-53) in the ‘out position’ furthest away from the main rotors (15-39) radius with counter weight (52-53) design, not to scale

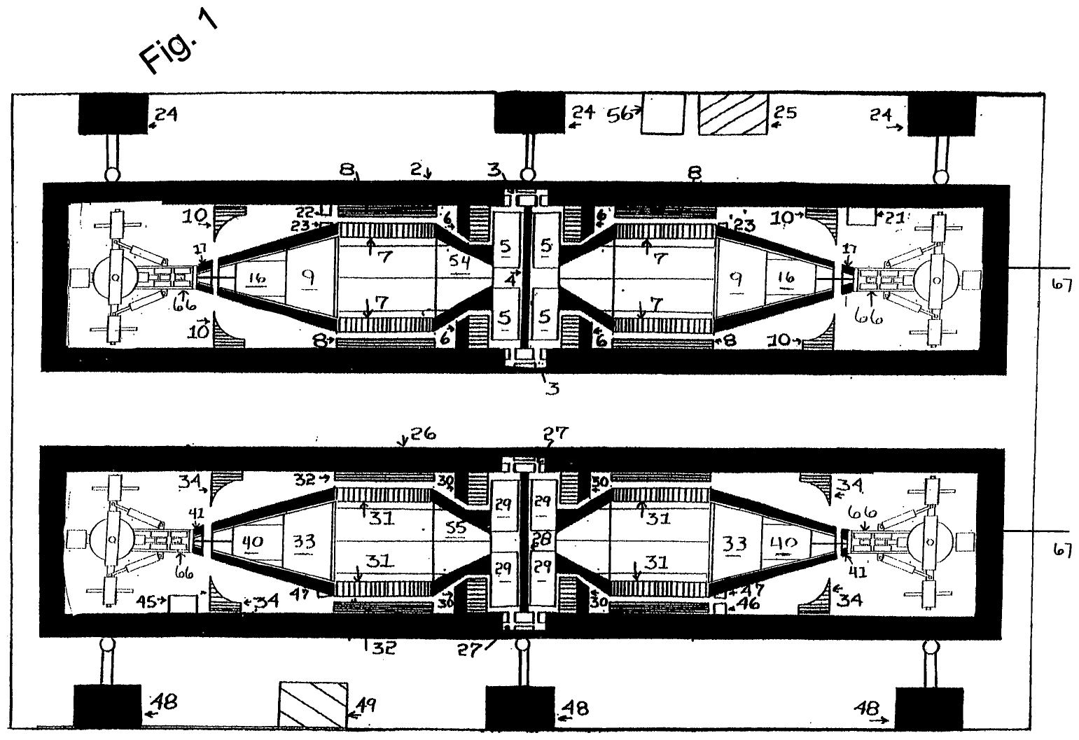

FIG. 2: Cutaway view of the AAMD, showing its internal components, with the gyroscopes (19-43) in the ‘out position’ furthest away from the main rotors (15-39) radius and the counter weights (52-53) in the ‘in position’ closest to the main rotors (15-39) radius with counter weight (52-53) design, Gyroscope assembly with linkage (57)

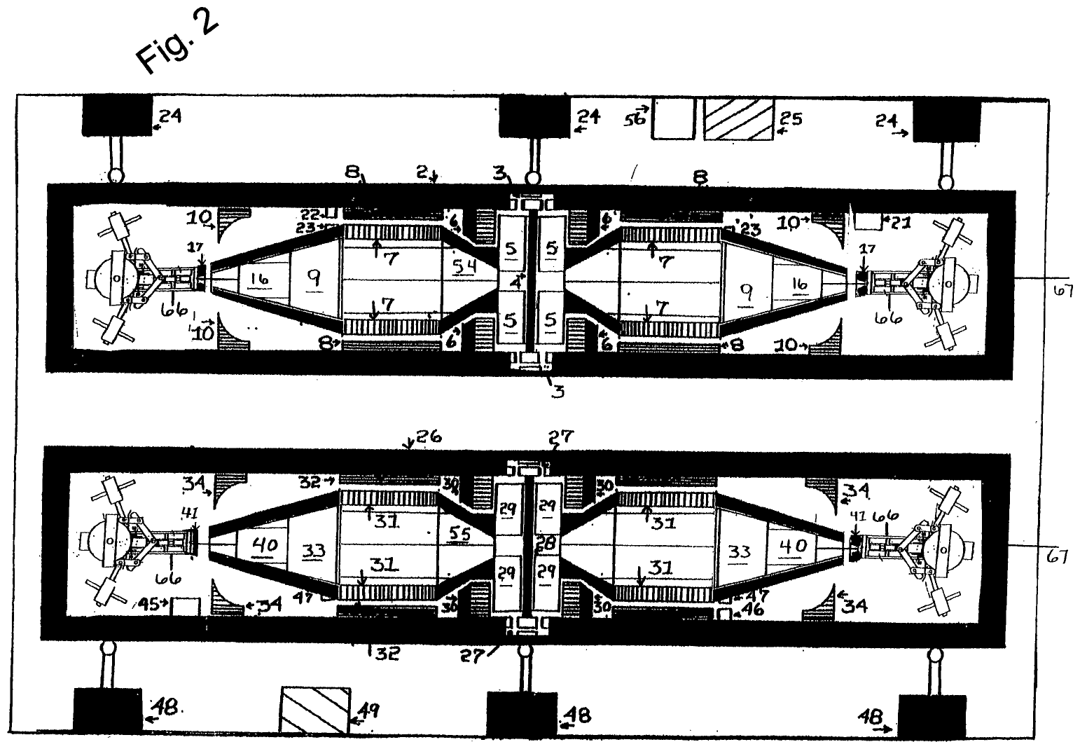

FIG. 3: Cutaway view of the AAMD, showing its internals components, with the altitude control system, not to scale

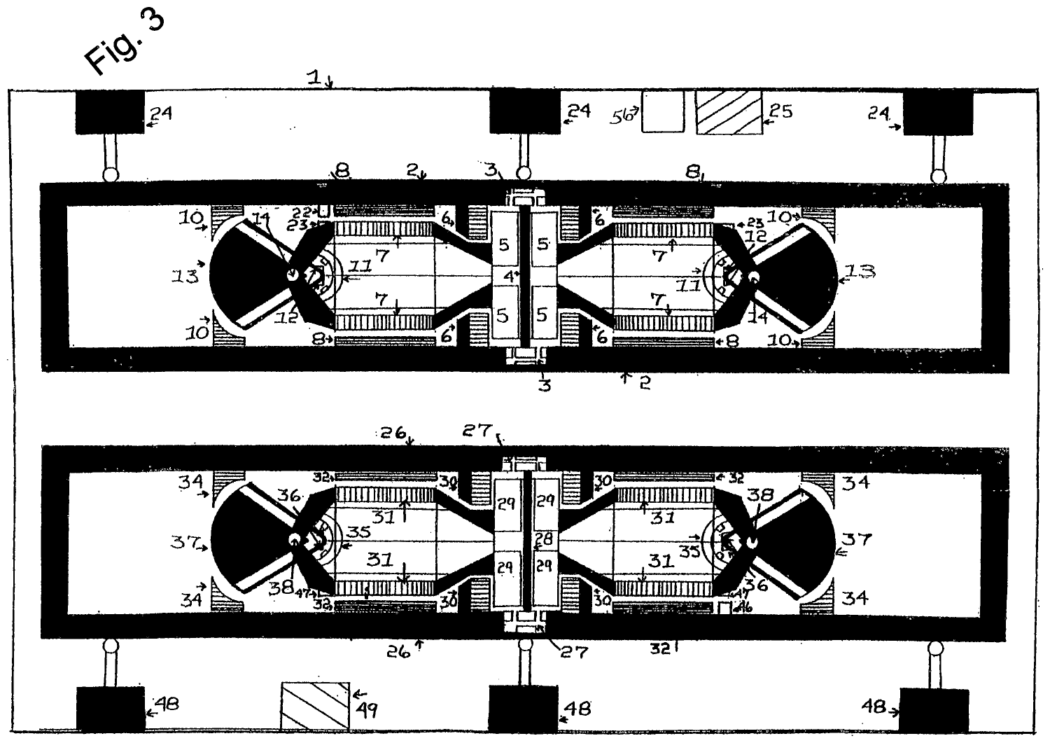

FIG. 4: Straight on view of the gyroscopes (19-43) assembly showing its components

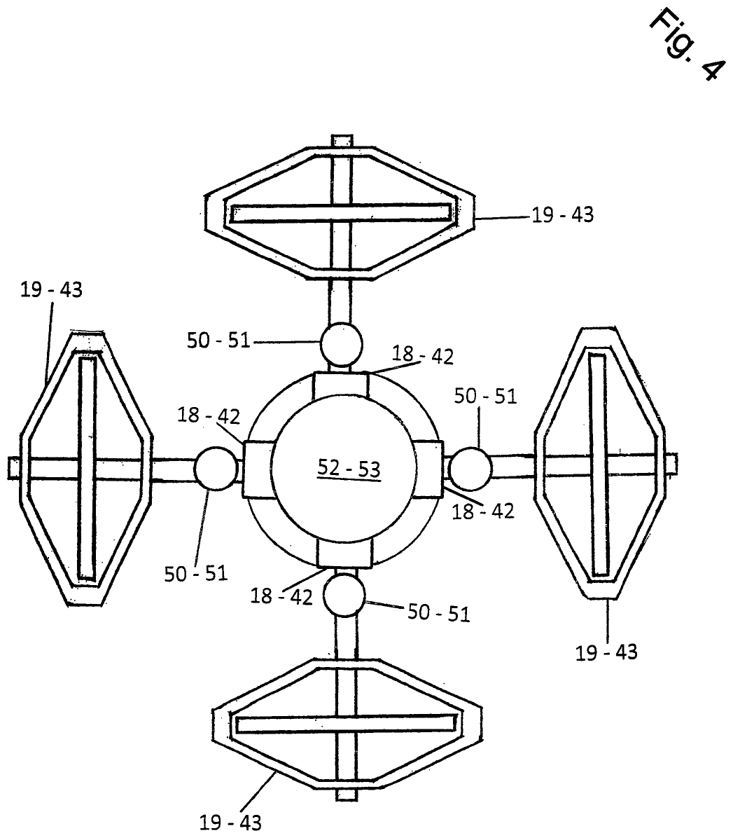

FIG. 5: Side view of the Gyroscope assembly with linkage for gyroscopes and counter weights (57) showing its components, with the gyroscopes (19-43) in the ‘in position’ and the counter weights (52-53) in the ‘out position’ with counter weight (52-53) design, not to scale

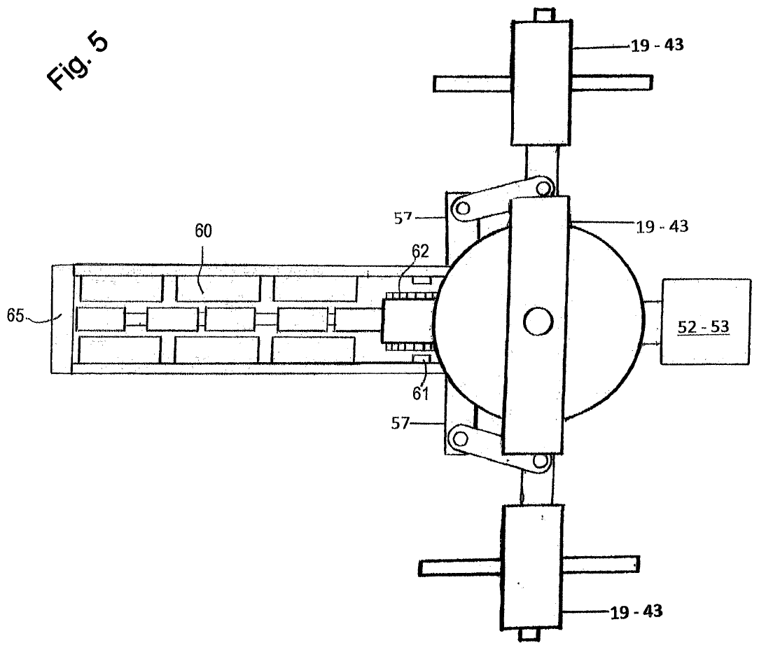

FIG. 6: Side view of the Gyroscope assembly with linkage for gyroscopes and counter weights (57) showing its components, with the gyroscopes (19-43) in the ‘out position’ and the counter weights (52-53) in the ‘in position’ with counter weight (52-53) design, not to scale

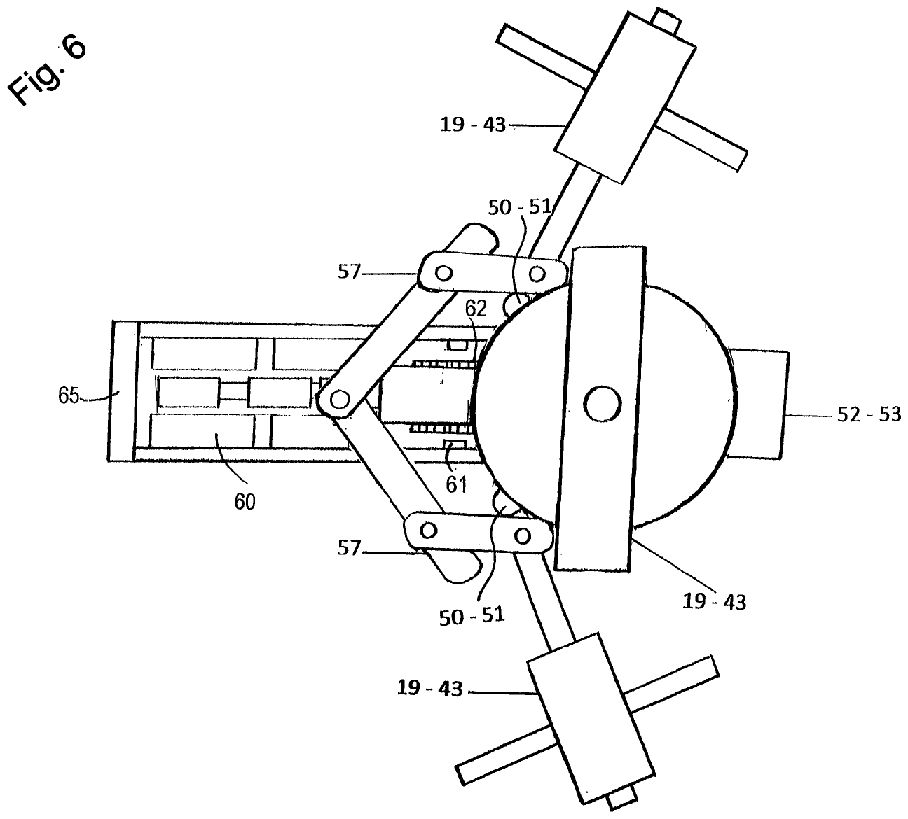

FIG. 7: Cutaway view of the AAMD, showing its internal components, with the gyroscopes (19-43) in the ‘in position’ closest to the main rotors (15-39) radius and the counter weights (52-53) in the ‘out position’ furthest away from the main rotors (15-39) radius with linear motor for gyroscopes (66) design, not to scale

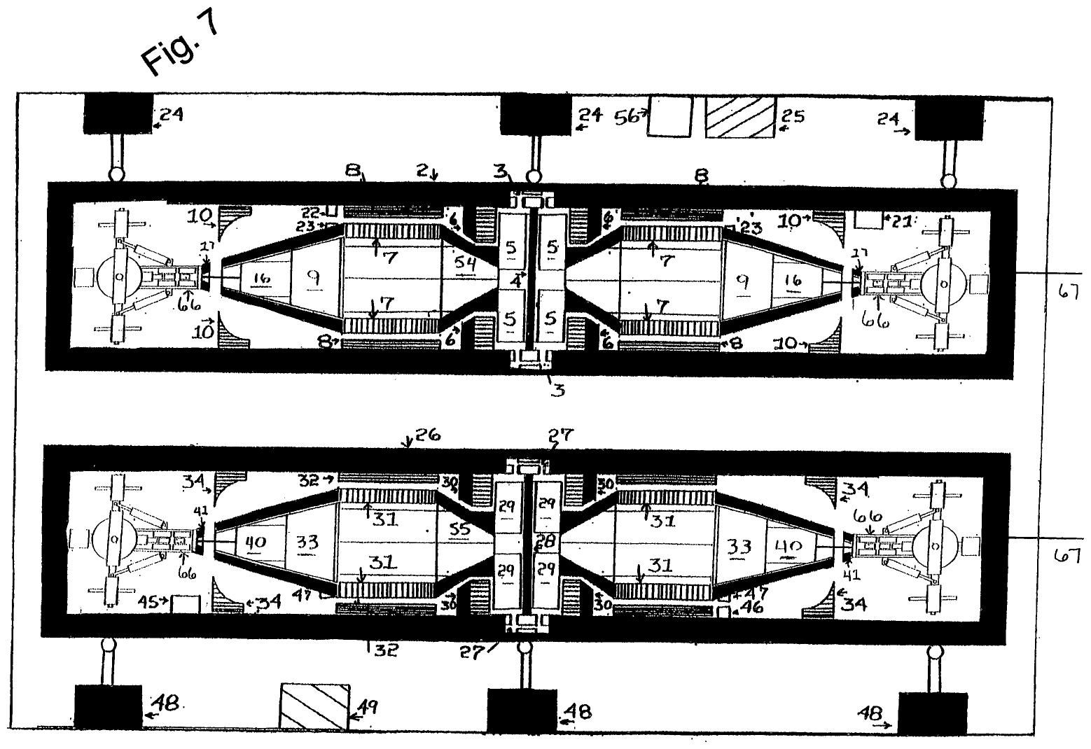

FIG. 8: Cutaway view of the AAMD, showing its internal components, with the gyroscopes (19-43) in the ‘out position’ furthest away from the main rotors (15-39) radius and the counter weights (52-53) in the ‘in position’ closest to the main rotors (15-39) radius with linear motor for gyroscopes (66) design, not to scale

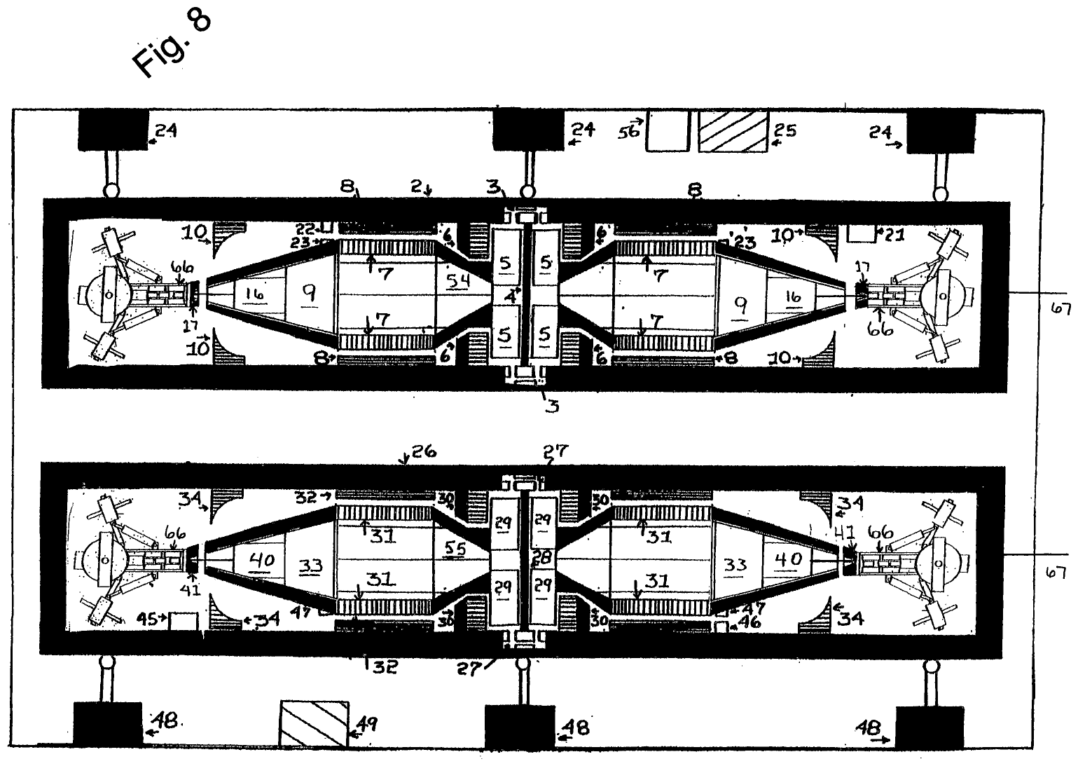

FIG. 9: Side view of the Gyroscope assembly with linear motor for gyroscopes and counter weights (66) design showing its components, with the gyroscopes (19-43) in the ‘in position’ closest to the main rotors (15-39) radius and the counter weights (52-53) in the ‘out position’ furthest away from the main rotors (15-39) radius with linear motor for gyroscopes (66) design, not to scale

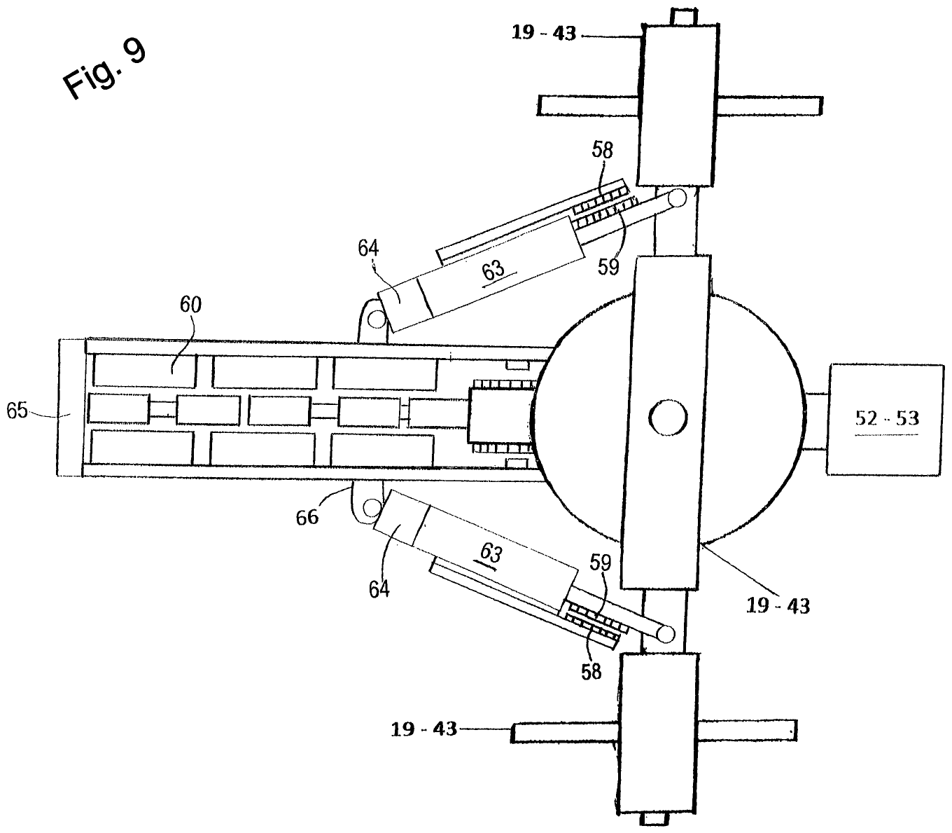

FIG. 10: Side view of the Gyroscope assembly with linear motor for gyroscopes and counter weights (66) design showing its components, with the gyroscopes (19-43) in the ‘out position’ furthest away from the main rotors (15-39) radius and the counter weights (52-53) in the ‘in position’ closest to the main rotors (15-39) radius with linear motor for gyroscopes (66) design, not to scale

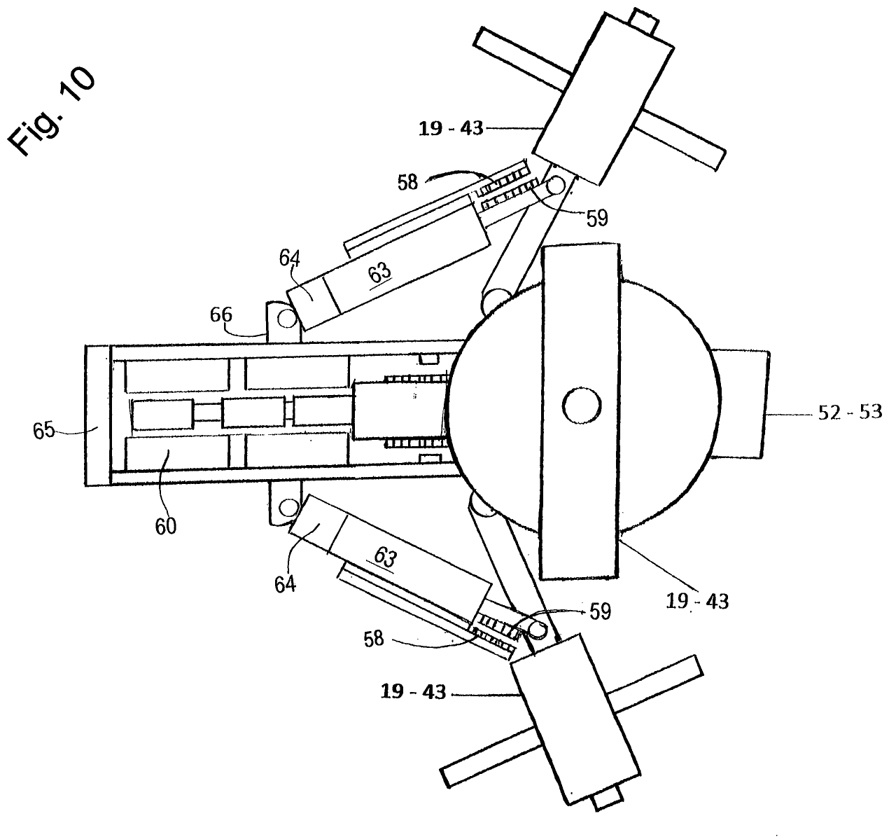

### REFERENCE CHARACTERS

### Components

1. AAMD main outer case

2. Rotor 1 outer case

3. Rotor 1 magnetic bearings system

4. Rotor 1 main shaft

5. Rotor 1 permanent magnet main rotor motor/generator

6. Rotor 1 main rotor motor/generator coils

7. Rotor 1 motor/generator coils

8. Rotor 1 motor/generator stator coils

9. Rotor 1 orbital motors/generators

10. Rotor 1 180 degree attitude control stator coils

11. Rotor 1 permanent magnets connected to main rotor

12. Rotor 1 permanent magnets connected to altitude control magnets

13. Rotor 1 attitude control magnets

14. Rotor 1 magnetic bearing system

15. Rotor 1 main rotor

16. Rotor 1 large gyroscope motors/generators

17. Rotor 1 orbital motor/generator, gyroscope assembly connector

18. Rotor 1 small gyroscope motors/generators

19. Rotor 1 gyroscopes

20. Rotor 1 deleted

21. Rotor 1 Vacuum pump

22. Rotor 1 main rotor sensor pick up

23. Rotor 1 main rotor sensor

24. Rotor 1 Propulsion director motors

25. Rotor 1 Central computer

26. Rotor 2 outer Case

27. Rotor 2 magnetic bearings system

28. Rotor 2 main shaft

29. Rotor 2 permanent magnet main motor/generator

30. Rotor 2 main rotor main motor/generator coils

31. Rotor 2 motor/generator coils

32. Rotor 2 motor/generator stator coils

33. Rotor 2 orbital motors/generators

34. Rotor 2 180 degree attitude control stator coils

35. Rotor 2 permanent magnets connected to main rotor

36. Rotor 2 permanent magnets connected to altitude control magnets

37. Rotor 2 attitude control magnets

38. Rotor 2 magnetic bearing system

39. Rotor 2 main rotor

40. Rotor 2 large gyroscope motors/generators

41. Rotor 2 orbital motor/generator, gyroscope assembly connector

42. Rotor 2 small gyroscope motors/generators

43. Rotor 2 gyroscopes

44. Rotor 2 deleted

45. Rotor 2 Vacuum pump

46. Rotor 2 main rotor sensor pick up

47. Rotor 2 main rotor sensor

48. Rotor 2 propulsion director motors

49. Rotor 2 central computer

50. Rotor 1 gyroscope pivot points

51. Rotor 2 gyroscope pivot points

52. Rotor 1 Counter weight

53. Rotor 2 Counter weight

54. Rotor 1 power controller for the main rotor stators

55. Rotor 2 power controller for the main rotor stators

56. Main power control system

57. Gyroscope assembly with linkage for gyroscopes and counter weights

58. Gyroscope and counter weight positioning sensors

59. Gyroscope and counter weight positioning pickups

60. Linear motors for counter weights and gyroscopes

61. Counter weight and gyroscope positioning sensors

62. Counter weight and gyroscope positioning pickups

63. Linear motor for gyroscopes

64. Capacitors/electrical energy source for linear motor for gyroscopes

65. Capacitors/electrical energy source for linear motors for counter weights

66. Gyroscope assembly

67. Electrical input

### DETAILED DESCRIPTION OF THE INVENTION

The invention consist an AAMD main outer base (1) to contain all but not limited to: components. There are but not limited to: 2-Outer cases (2-26). There are but not limited to: 2-counter rotating Main rotors (15-39) which are supported by a Main shafts (4-28) and but not limited to: Magnetic bearing system (3-27).

Each Main rotors (15-39), contain but not limited to: a Permanent magnet main rotor motor/generator (5-29), Main rotor motor/generator coils (6-30), which can operate as either a motor by control means to supply input power to the said Main rotors (15-39), or operate as a generator by control means, converting the stored kinetic energy to electrical energy from said Main rotors (15-39).

There are motor/generator coils (7-31), and motor/generator stator coils (8-32) but not limited to: all around the said Main rotors (15-39) after the Permanent magnet main rotor motor/generator (5-29), Main rotor motor/generator coils (6-30), away from the Main shafts (4-28).

The motor/generator coils (7-31), and motor/generator stator coils (8-32) can operate as either a motor or a generator by control means and can provide electrical power to the Main rotors (15-39), components.

Moving further out and away from the Main shafts (4-28), in the Main rotors (15-39), there are but not limited to: 8-Altitude control magnets (13-37) and the 180 degree altitude control stator coils (10-34). The Altitude control magnets (13-37) are held in proper position by means of the Permanent magnets connected to main rotors (11-35), and the Permanent magnets connected to altitude control magnets (12-36).

The Altitude control magnets (13-37) are supported by means of but not limited to: the Magnetic bearing system (14-38).

Moving further out and away from the Main shafts (4-28), in the Main rotors (15-39), there are but not limited to: 8-Orbital motor/generators (9-33), and can operate as either a motor or generator by control means and can be powered by means of the motor/generator coils (7-31), and motor/generator stator coils (8-32).

There are Main rotors sensor pickups (22-46) and Main rotors sensors (23-47), to enable monitor the proper Main rotors (15-39) position at all times.

Moving further out and away from the Main shafts (4-28), in the Main rotors (15-39), there are but not limited to: there are but not limited to: 8-Orbital motor/generator, gyroscope assembly connectors (17-41), 8-Large gyroscope motors/generators (16-40) and can operate as either a motor or generator by control means and enables input power to the Capacitors/electrical energy source for linear motor for gyroscopes (64) and the Capacitors/electrical energy source for linear motors for counter weights (65).

There are Vacuum pumps (21-45) that enables the Main rotors (15-39) to but not limited to: operate in a vacuum to reduce drag.

Moving further out and away from the Main shafts (4-28), in the Main rotors (15-39), there are but not limited to: there are but not limited to: 8-Gyroscope assembly's (66) per Main rotors (15-39).

Within each of the Gyroscope assembly's (66), there are but not limited to: 4-Small gyroscope motors/generators (18-42), 4-Gyroscopes (19-43), Gyroscope pivot points (50-51), Rotor 1-2 Counter weights (52-53), and it can have but not limited to: either a Gyroscope assembly with linkage for gyroscopes and counter weights (57) and/or Linear motors for counter weights and gyroscopes (60) and Linear motors for gyroscopes (63), (18-42), Gyroscope positioning sensors (58), Gyroscope positioning pickup (59), to enable monitor the proper 4-Gyroscopes (19-43) position at all times.

Capacitors/electrical energy source for linear motor for gyroscopes (64), Capacitors/electrical energy source for linear motor for counter weights (65), Counter weight positioning sensor (61), Counter weight positioning pickup (62), to enable monitor the proper Counter weights (52-53) position at all times.

Rotor 1-2 power controller for the main rotor stators (54-55), for control means for the motor/generator coils (7-31), and motor/generator stator coils (8-32) and the Main power control system (56) to control but not limited to: all electrical power on the Main rotors (15-39) as well as an Electrical input (67) to the invention.

There are but not limited to: 2-Rotor 1-2 Central computers (25-49) that by control means, completely control all aspects of the invention.

There are but not limited to: 4-Rotor 1-2 Propulsion director motors (24-48) that enables control means of directing each Main rotors (15-39) independently by means of the Rotor 1-2 Central computer (25-49).

In a spinning system with a moveable mass at the outer rim, when a mass moves away from the radius. The angular momentum is conserved, the mass is constant. When the radius is decreased, the velocity must increase.

If the radius is less, the moment of inertia is less. L=r m v. Due to the law of angular momentum conservation, the angular velocity increases when the moment of inertia decreases. L=I w. A moveable mass rotor can increase angular velocity by decreasing the moment of Inertia as the angular momentum is conserved. Inertia decreases-velocity increases. The speed increase is due a decrease in the moment of inertia. I=m r².

Notice the AAMD's main rotors (15-39), orbital motors/generators (9-33) and gyroscopes (19-43) function in the exact opposite manner?

When the orbital motors/generators (9-33) function as a generator, the angular velocity of the gyroscopes (19-43) rotating around the orbital motors/generators (9-33) axis, are reduced and the but not limited to: centripetal and centrifugal force produced from the main rotors (15-39) and the produced precessional torque, gyroscopic force by means of the gyroscopes (19-43) and the linear motor for gyroscopes (63).

Causing them to move out from their original position of their maximum diameter by means of the Gyroscope pivot points (50-51) and radius of the orbital motors/generators (9-33) and the gyroscopes (19-43) ‘stretch’ outward away from the main rotors (15-39) radius, by means of the Gyroscope pivot points (50-51). Then the gyroscopes (19-43) ‘stretch’ outward, they exhibit a reduced diameter of their spin path.

In a naturally occurring environment, the reduced diameter would produce a higher angular velocity of the orbital motors/generators (9-33). Instead, the orbital motors/generators (9-33) and the gyroscopes (19-43) are ‘forced’ to decrease in angular velocity by means of Lenz's law, the physical resistance to magnetic induction being placed on the orbital motors/generators (19-43) functioning as generators.

This produces an electrical output from the stored rotational kinetic energy and produces a torque action placed on the main rotors main shaft (4-28) with the produced but not limited to: precessional, gyroscopic, centripetal and centrifugal forces, torque by means of the gyroscopes (19-43) in the 180 degree opposite direction that the orbital motors/generators (9-33) are operating as a generator.

When the orbital motors/generators (9-33) function as a motor, the angular velocity of the 4-gyroscopes (19-43) is increased and but not limited to: the centripetal and centrifugal force produced from the orbital motors/generators (9-33) are applied to the gyroscopes (19-43) with the linear motor for gyroscopes (63).

This ‘forces’ the gyroscopes (19-43) diameter to be increased back to their original maximum diameter radius by means of the Gyroscope pivot points (50-51) to the orbital motors/generators (9-33) and causing them to move in from their outward position move back inward towards the main rotors radius. Then the gyroscopes (19-43) exhibit an increased diameter of their spin path.

The increased angular velocity from the orbital motors/generators (9-33) places but not limited to: the centripetal, centrifugal force and the linear motor for gyroscopes (63) force the gyroscopes (19-43) back to their maximum diameter and overcome the centripetal and centrifugal force produced from the main rotors (15-39) and the produced precessional, gyroscopic, centripetal and centrifugal forces by means of the gyroscopes (19-43).

In a naturally occurring environment, the increased diameter would produce a lower angular velocity of the orbital motors/generators (9-33). Instead, the orbital motors/generators (9-33) and the gyroscopes (19-43) are ‘forced’ to increase in angular velocity by means of electrical input to the orbital motors/generators (9-33) and produces a torque action placed on the main shaft (4-28).

With the produced but not limited to: precessional, gyroscopic, centripetal and centrifugal forces torque by means of the gyroscopes (19-43) in the 180 degree opposite direction that the orbital motors/generators are operating as a motor.

There is an equally and opposite reaction taking place by means of operating the orbital motors/generators as a generator (9-33) and ‘force’ the gyroscopes (19-43) to reduce their angular velocity and operating the orbital motors/generators (9-33) as a motor and ‘force’ the gyroscopes (19-43) to increase their angular velocity.

This is performed in the opposite manner as in nature and produces a twisting and torqueing action in an equally and opposite manner at 90 degrees apart from each other. The gyroscopes (19-43) combined connected to the orbital motors/generators (9-33) are a gyroscope in themselves.

With their full range Gyroscope pivot points (50-51) allowing outward and inward movement from the main rotors (15-39) axis, this enables the constantly changing angular momentum and produced but not limited to: precessional, gyroscopic, centripetal and centrifugal forces to move slightly as the orbital motors/generators (9-33) rotate.

The Gyroscope pivot points (50-51) enable the capability of the gyroscopes (19-43) to contain a moveable mass located at the outer rim. Then the 4 moveable outer rim masses, by means of the Gyroscope pivot points (50-51) and 4 gyroscopes (19-43), produce one gyroscope themselves, combined. The 4-gyroscopes (19-43) operate as one large gyroscope when spun by means of the orbital motors/generators (9-33).

So the 4 small gyroscopes (19-43), are separated 90 degrees apart from each other's rotation of axis. Then the 4-gyroscopes (19-43), are functioning as one gyroscope is functioning 90 degrees from the orbital motors/generators (9-33) radius. Then the orbital motors/generators (9-33) are functioning 90 degrees apart from the 2-counter rotating main rotors (15-39) radius.

It's the unique 3 plane spinning masses, with their 90 degree separations, and the gyroscopes (19-43), which are ‘forced’ to decrease or increase their angular velocity by means of the orbital motors/generators (9-33).

Then the produced but not limited to: precessional, gyroscopic, centripetal and centrifugal forces torque by means of the gyroscopes (19-43) with the linear motor for gyroscopes (63), that is the exact opposite of the naturally occurring process of the conservation of angular momentum, that produces an internal action.

The AAMD tractive manner in which the, ‘push’ action is accomplished is by means of the 4-spinning gyroscopes (19-43), functioning as one larger gyroscope. Then they are that are ‘forced’ to quickly reduce their angular velocity when the conservation of angular momentum wants them to increase angular velocity.

Combined but not limited to: with the linear motor for gyroscopes (63) and produced but not limited to: precessional, gyroscopic, centripetal and centrifugal forces torque by means of the gyroscopes (19-43). This twisting, torqueing produced is achieved by means of the 2-90 degree offsets, the main rotors (15-39), orbital motors/generators (9-33) and the gyroscopes (19-43).

This quick movement of the gyroscopes (19-43) allows the AAMD to momentarily have a small ‘attaching point’ for the main rotors (15-39) as the ‘push’ off by means of the providing a directional tractive force by means of the central computers (25-49) and cause a ‘push’ to the main shafts (4-28).

Without a negative repulsive force due to the cancelation of the repulsive force being canceling out 90 apart from the directional force and with the 2 counter rotating rotors (15-39) they are canceled out completely with only directional linear thrust for propulsion.

The AAMD tractive manner in which the, ‘pull’ action is accomplished is by means of the 4-spinning gyroscopes (19-43), functioning as one larger gyroscope. Then they are that are ‘forced’ to quickly increase their angular velocity when the conservation of angular momentum wants them to decrease angular velocity, combined with the linear motor for gyroscopes (63).

The produced but not limited to: precessional, gyroscopic, centripetal and centrifugal forces torque by means of the gyroscopes (19-43). This twisting, torqueing produced is achieved by means of the 2-90 degree offsets, the main rotors (15-39), orbital motors/generators (9-33) and the gyroscopes (19-43).

This quick movement of the gyroscopes (19-43) allows the AAMD to momentarily have a small ‘attaching point’ for the main rotors (15-39) as the ‘pull’ from by means of the providing a directional tractive force by means of the central computers (25-49) and cause a ‘pull’ to the main shafts (4-28) without a negative repulsive force due to the cancelation of the repulsive force being canceling out 90 apart from the directional force and with the 2 counter rotating rotors (15-39) they are canceled out completely with only directional linear thrust for propulsion.

The tractive force is proportional to the rate of change of momentum and the law regarding energy is that it can neither be created, nor destroyed. It came from a source and must be absorbed and never lost.

This AAMD ‘Push’-'Pull' action, functions as a high speed, constantly turning, ‘gyroscopic screw’ with a ‘tractive force’, by means of the gyroscopes (19-43), orbital motors/generators (9-33) and the 2-counter rotating main rotors (15-39) operating 180 degrees apart from each other.

This 180 degree total separation from the gyroscopes (19-43), axis and the main rotors (15-39) axis, enables the AAMD to produce a reaction with an equally and opposite reaction and display an internal directional linear thrust capability.

There are 3 different elements that need to be examined. First, the main rotors (15-39), they are in a sense gravity multipliers and one of the means of increasing and decreasing the thrust output from the system. Second, the orbital motor/generators (9-33) are spun at a calculated angular velocity.

Third, there are the 4-gyroscopes (19-43), per orbital motor/generator (9-33). Their angular velocity is calculated as to produce an outward force away from the orbital motor/generator (9-33) axis and reach the largest diameter by means of theGyroscope pivot points (50-51).

When the main rotors (15-39) began to turn, the mass of the gyroscopes (19-43) want to move towards the outer part of the main rotor's (15-39) rim and away from the main rotors axis (4-28).

The orbital motors/generators (9-33) will but not limited to: increase their angular velocity and the gyroscopes (19-43) will maintain their maximum diameter, by means of the Gyroscope pivot points (50-51), furthest away from the orbital motors/generators (9-33) axis.

The gyroscopes (19-43) want to resist the 2 spin vectors from the main rotors (15-39) and the orbital motors/generators (9-33). The gyroscopes (19-43) are also subjected to the produced, centripetal and centrifugal forces by means of the angular velocity of the main rotors (15-39).

The high angular velocity of the orbital motors/generators (9-33) overpower the gyroscopes (19-43) resistance to move towards the outer part of the main rotor's (15-39) rim and away from the main rotors axis (4-28) and resistance the main rotors (15-39) produced centripetal and centrifugal forces applied and follow the maximum diameter.

Since the gyroscopes (19-43) are operating in a dual 90 degree plane separation, the resistance encountered by the spinning gyroscopes (19-43) by the introduction of an external torque, from both the main rotors (15-39) and the orbital motors/generators (9-33), enable the feasibility of a directional linear thrust system, by means of the counter torque is being placed at 90 degrees from the external torque.

This process bypasses the 180 degree self-cancelation torque that is generally observed and being applied to the main rotors (15-39) axis. Therefore the system exhibits but not limited to: 3:00 or 9:00 average reactionary torque from a 6:00 or a 12:00 average directional torque. Since there are 2-counter rotating main rotors (15-39). The 3:00 or 9:00 average reactionary torque is self-cancelling per Newton's 3rd law of motion.

There is a net directional torque-thrust when the AAMD moves the gyroscopes (19-43) in the 6:00 average position and when the system moves the gyroscopes (19-43) in the 12:00 position. The torque applied at the 3:00 or 9:00 average position, is equal to the torque applied at the 6:00 or 12:00 average position.

Producing and equal and opposite reaction but with a 90 degree offset due to the main rotors (15-39), orbital motor/generators (9-33), and spinning gyroscopes (19-43). It's the dual 90 degree separation of the torque vectors and force vectors that enable this devise not to violate any laws of motion.

When the orbital motors/generators (9-33), are forced to reduce angular velocity, by means of the orbital motors/generators (9-33), functioning as a generator, lowers the centripetal and centrifugal forces applied to the gyroscopes (19-43). Then the centripetal and centrifugal forces applied from the main rotors (15-39), with the linear motor for gyroscopes (63), overwhelm the now reduced angular velocity of the gyroscopes (19-43) combined with the produced precessional, gyroscopic, centripetal and centrifugal forces torque by means of the gyroscopes (19-43).

The gyroscopes (19-43) begin to move away from their once original path of motion, with their maximum diameter, by means of the Gyroscope pivot points (50-51). The gyroscopes (19-43) now elongate out towards the outer part of the main rotor (15-39), away from the main rotors (15-39) radius.

This lower angular velocity of the orbital motors/generators (9-33), with the reduced diameter of the spinning gyroscopes (19-43), by means of the Gyroscope pivot points (50-51), is the exact opposite of the naturally occurring the conservation of angular momentum. Whereas, when a spinning mass is brought closer to the radius, there is an increase in angular velocity.

The 180 degree offset and the ‘forced’ counter conservation of angular momentum movement, provides a directional torque applied to the system at but not limited to: 6:00 average position towards the 12:00 average position. With a counter torque by means of the dual 90 degree offset, but not limited to: 3:00 or 9:00 average position, depending on which direction of the rotating main rotors (15-39).

The attached counter weights (52-53) are draw inward towards the main rotors radius, away from the main rotors (15-39) rim, by means of the linear motors for counter weights and gyroscopes (60) and the central computers (25-49).

This movement of the gyroscopes (19-43) mass moving outward by means of the linear motor for gyroscopes (63) and the applied centripetal and centrifugal forces from the main rotors (15-39) to the counter weight (52-53), linear motors for counter weights and gyroscopes (60) and the counter weights (52-53) moving inward allows the main rotors (15-39) to experience a completely balanced system, throughout the inward and outward movement of the gyroscopes (19-43) and counter weights (52-53).

When the orbital motors/generators (9-33), are forced to increase angular velocity, by means of the orbital motors/generators (9-33), functioning as a motor, increases the centripetal and centrifugal forces applied to the gyroscopes (19-43).

Now the centripetal and centrifugal forces applied by means of the increased angular velocity of the gyroscopes (19-43) with the linear motor for gyroscopes (63), overwhelm the main rotors applied centripetal and centrifugal forces, combined with the produced precessional, gyroscopic, centripetal and centrifugal forces by means of the gyroscopes (19-43).

The gyroscopes (19-43) begin to move back towards their once original spin path of motion, with their maximum diameter, by means of theGyroscope pivot points (50-51). The gyroscopes (19-43) now move back towards the main rotor (15-39) radius.

This higher angular velocity of the orbital motors/generators (9-33), with the increased diameter of the spinning gyroscopes (19-43), by means of the Gyroscope pivot points (50-51), is the exact opposite of the naturally occurring the conservation of angular momentum. Whereas, when a spinning mass is brought further from the radius, there is a decrease in angular velocity.

The 180 degree offset and the ‘forced’ counter conservation of angular momentum movement provides a directional torque applied to the system at but not limited to: 6:00 average position towards the 12:00 average position. With a counter torque by means of the dual 90 degree offset, but not limited to: 3:00 or 9:00 average position, depending on which counter rotating rotor (15-39).

The attached counter weights (52-53) are now pushed outward away from the main rotors (15-39) radius by means of the linear motor for counter weights (60) and the gyroscopes (19-43) mass moving in an inward direction, towards the main rotors radius (4-28) by means of the orbital motors/generators (9-33) and the linear motor for gyroscopes (63), combined with the produced precessional, gyroscopic, centripetal and centrifugal forces torque by means of the gyroscopes (19-43).

This movement of the gyroscopes (19-43), mass moving inward by means of the linear motor for gyroscopes (63) and the applied centripetal and centrifugal forces from the increase in angular velocity from the orbital motors/generators (9-33) and the counter weights (52-53) moving outward, by means of the linear motor for counter weights (60) allows the main rotors (15-39) to experience a completely balanced system, throughout the movement of the gyroscopes (19-43) and counter weights (52-53).

The central computers (25-49) can but not limited to: direct the propulsion system in any of the 360 degrees all around the vehicle, within one degree. The central computers (25-49) can enable the main rotors (15-39), orbital motors/generators (9-33) and gyroscopes (19-43) to rotate in any direction independent to each other. The central computers (25-49) can enable the main rotors (15-39), orbital motors/generators (9-33) and gyroscopes (19-43) to rotate in any angular velocity independent to each other.

There are propulsion director motors (24-48) that are controlled by means of the central computers (25-49) and can move each one of the main rotors (15-39) independently of in unison when desired. The propulsion director motors (24-48) direct the directional linear thrust in but not limited to: up and down fashion as to enable the AAMD to produce more than just a straight line thrust and assist the altitude control system within the AAMD to enable it to provide proper flight control.

The rate of change of angular momentum is equal to torque. The relationship between angular momentum and torque is the same as linear momentum and force.

In layman terms: the two counter rotating main rotors maintain a seamlessly balanced system at all times, throughout the operation, and acts as a perfectly balanced, spinning motor, by means of the counter weights moving closer and further from the radius to fully compensate the movement of the 4-gyroscopes moving further and closer from the radius.

The distance from the moveable masses at the outer rim of the main rotors, to radius is always equal and balanced. The “forced rapid movement” of the 4-gyroscopes moving further and closer from the radius, exceeds the force required for the “rapid movement” of the counter weights moving closer and further from the radius.

This combined with the self-cancelation effect, from the counter rotating main rotors, enables the AAMD ‘Push’-'Pull' action, functions as a high speed, constantly turning, ‘gyroscopic screw’ with a ‘tractive force’, by means of the gyroscopes (19-43), orbital motors/generators (9-33) and the 2-counter rotating main rotors (15-39) operating 180 degrees apart from each other.

The angular velocity of the orbital motors/generators is high enough to exceed the precessional forces from the 4-gyroscopes and the angular velocity of the main rotors. By means of the high angular velocity from the orbital motors/generators, forces the 4-gyroscopes to function as one large gyroscope, in a large diameter.

Then when encountering a lower angular velocity from the orbital motors/generators, forces the 4-gyroscopes and the Gyroscope pivot points, enables the 4-gyroscopes to be extended in their most outward distance, from the axis of rotation of the orbital motors/generators, in a smaller diameter, due to the angular velocity of the main rotors.

### Method of Operation

First, there is electrical input needed to power the AAMD either but not limited to: a nuclear reactor for spaceships, submarines, solar panels or a radioscope thermoelectric generator for satellites. This power is distributed into a power control system (56) the power control system (56) is controlled by the central computers (25-49). The central computers (25-49) can but not limited to: direct the propulsion system in any of the 360 degrees all around the vehicle, within one degree.

The central computers (25-49) can enable the main rotors (15-39), orbital motors/generators (9-33) and gyroscopes (19-43) to rotate in any direction independent to each other. The central computers (25-49) can enable the main rotors (15-39), orbital motors/generators (9-33) and gyroscopes (19-43) to rotate in any angular velocity independent to each other.

To start the AAMD, the central computers (25-49) instructs the main power control system (56) to send the electrical power to the main rotors (15-39) main rotor motor/generator coils (6-30). This creates a magnetic field, which interacts with but, not limited to: permanent magnet main rotor motor/generator (5-29), which are placed within the main rotors (15-39).

Then the main rotors (15-39) start to rotate. Also at the same instance the electrical input power is distributed to the main rotor stator coils (8-32). This creates a magnetic field, which interacts with the rotor coils (7-31), which produces an electrical output. This electrical power is distributed to power conditioners that are built into each of but not limited to: 8 orbital motors/generators (9-33), which are placed within the main rotors (15-39) 45 degrees apart.

The electrical input power interacts with the orbital motors/generators (9-33), which causes them to turn. There are main rotor power control systems (54-55) that control the power to and from the main rotor stator coils (8-32), the rotor coils (7-31) and the orbital motor/generators (9-33). Connected to each orbital motor/generators (9-33), there are the large gyroscope motors/generators (16-40) and can but not limited to: transfer their electrical power to the Gyroscope assembly (66), by means of a brush and/or brushless system.

Connected to the orbital motor/generator, gyroscope assembly connectors (17-41) there are but not limited to: four small gyroscope motors (18-42), connected to the small gyroscope motors (18-42), are the gyroscope pivot points (50-51), the small gyroscope motors (18-42) are spaced but not limited to: 90 degrees apart from each other.

There are linear motor for gyroscopes (63) that are configured in all around the gyroscopes (19-33) but not limited to: 90 degrees apart from each other. The linear motors for gyroscopes (63) are connected to but not limited to: each gyroscope (19-43). The linear motors for gyroscopes (63) are controlled by means of the central computers (25-49).

There are capacitors/electrical energy source for linear motors for gyroscopes (64) that are controlled by means of the central computers (25-49) and charged up by means of the large gyroscope motors/generators (16-40).

The linear motors for gyroscopes (63) can function but not limited to: both the inward and outward direction, by control means of the central computers (25-49). The inward direction moves the gyroscopes (19-43) towards the main rotors (15-39) radius. The outward direction moves the gyroscopes (19-43) away from the main rotors (15-39) radius.

The capacitors/electrical energy source for linear motors for gyroscopes (64) is but not limited to: charged the entire time by means of the large gyroscope motors/generators (16-40) and the operation of the linear motors for gyroscopes (63) by means of the central computers (25-49) allows for the capacitors/electrical energy source (64) to momentary dump their large amount of electrical stored energy quickly into the linear motors for gyroscopes (63) by means of control by the central computers (25-49).

There is a magnetic locking system built into the linear motors for gyroscopes (63) that can hold the gyroscopes (19-43) in any but not limited to: position the central computers (25-49) choose by means of the gyroscope positioning sensors (58) and gyroscope positioning pickups (59). The linear motors for gyroscopes (63) can be but not limited to: eliminated, if the counter weight (52-53) design is used to shift the gyroscopes (19-43) and counter weights (52-53).

There is another magnetic locking system that is but not limited to: by means of the built in the linear motors for counter weights and gyroscopes (60) and controlled by means of the central computers (25-49). The linear motors for counter weights and gyroscopes (60) are powered by means of the large gyroscope motors/generators (16-40) and the operation of the linear motors for counter weights and gyroscopes (60) by means of the central computers (25-49).

The capacitors/electrical energy source for linear motors for counter weights (65) is but not limited to: charged the entire time by means of the large gyroscope motors/generators (16-40) and the operation of the capacitors/electrical energy source for linear motors for counter weights (65) by means of the central computers (25-49).

This allows for the capacitors/electrical energy source (64) to momentary dump their large amount of electrical stored energy quickly into the linear motors for counter weights and gyroscopes (60) by means of control by the central computers (25-49).

The magnetic locking system in the counter weights (52-53) can lock in the inward and outward position, to and from the main rotor (15-39) axis and the linear motor for counter weights (60) can move the counter weights (52-53) inward and outward, to and from the main rotor (15-39) axis.

The counter weight can be but not limited to: any devise that moves a mass, towards and away from the main rotors (15-39) radius, to compensate for the mass of the gyroscopes that move towards and away from the main rotors (15-39) when the AAMD is operating and provide a completely balanced main rotors (15-39) the entire duration and is a key component to the system.

When the AAMD is operating, here is one method but not limited to the operation. The central computers (25-49) will instruct the main rotors (15-39) to begin to rotate in but not limited to: opposite directions from each other. The main rotors (15-39) angular velocity will be calculated by means of the central computers (25-49) main rotor sensor (23-47) and the main rotor sensor pickup (22-46).

At the same time of the main rotors (15-39) begin to rotate, the orbital motors/generators (9-33) begin to rotate by means control of the central computers (25-49). There are but not limited to: 8-orbital motors/generators (9-33) for each main rotors (15-39), separated 45 degrees apart from each other.

Also, the gyroscopes (19-43) begin to rotate up to operational speed by means control of the central computers (25-49). There are but not limited to: 4-gyroscopes for each orbital motors/generators (9-33), separated 90 degrees apart from each other.

The central computers (25-49) can but not limited to: operate the main rotors (15-39), orbital motors/generators (9-33) and the gyroscopes (19-43) independently by control means. The central computers (25-49) can calculate the angular velocity of the orbital motors/generators (9-33) to maintain a proper rotational speed as to allow the gyroscopes (19-43) to stay in their maximum diameter as they rotate by means of the gyroscope pivot points (50-51) and the main rotors (15-39) rotational force does not affect the position of the gyroscopes (19-43) to staying in their maximum diameter.

To make easy of the understanding of the timing of the AAMD. There are 60 minutes in an hour. 720 minutes in 12 hours. 360 degrees in a circle. Every minute in a clock is ½ of a degree. The orbital motors/generators (9-33) are spaced 90 minutes apart.

So, to produce a 12:00 directional linear thrust. The central computers (25-49) will but not limited to: produce a 45 minute operational window before 6:00, 5:15. Then produce a 45 minute operational window after 6:00, 6:45. 90 minutes total. When the gyroscopes (19-43) are forced in an outward direction, away from the main rotors (15-39) radius.

So, to produce a 12:00 directional linear thrust. The central computers (25-49) will but not limited to: produce a 45 minute operational window before 12:00, 11:15. Then produce a 45 minute operational window after 12:00, 12:45. 90 minutes total. When the gyroscopes (19-43) are forced in an inward direction, towards the main rotors (15-39) radius.

This is one but not limited to: operational procedure.

When the central computers (25-49) want to influence the AAMD system and produce an internal directional linear thrust, in but not limited to: the 12:00 position. The central computers (25-49) will but not limited to: instruct the orbital motors/generators (9-33) to begin to operate as a generator at 5:15 until 6:45, 6:00 average.

When the orbital motors/generators (9-33) operating as generators, their angular velocity is reduced. When the orbital motors/generators (9-33) begin to slow down, they will be influenced by means of the main rotors (15-39) angular velocity.

When the central computers (25-49) want to influence the system and produce an internal directional linear thrust, in but not limited to: the 12:00 position. The central computers (25-49) will but not limited to: instruct the orbital motors/generators (9-33) to begin to operate as a motor at 11:15 until 12:45, 12:00 average.

The central computers (25-49) can also control the intensity of the gyroscopes (19-43) by remote control means of the small gyroscope motors/generators (18-42) and remotely control the angular velocity of the gyroscopes (19-43) rotors and therefore their intensity and stored kinetic potential within the gyroscopes (19-43) and control their angular velocity independently.

To increase the directional linear thrust from the AAMD. The central computers (25-49) can but not limited to: increase the main rotors (15-39) angular velocity. This increase in revolutions per minute exerts a great outward force away from the main rotors (15-39) axis, forcing the gyroscopes (19-43) in an outward direction away from the main rotors (15-39) axis.

The central computers (25-49) can but not limited to: increase the orbital motors/generators (9-33) angular velocity. This increase in revolutions per minute exerts a great outward force away from the orbital motors/generators (9-33) axis, forcing the gyroscopes (19-43) in an outward direction away from the orbital motors/generators (9-33) axis, by means of the gyroscope pivot points (50-51) and the gyroscopes (19-43) stay in their maximum diameter.

There are but not limited to: 8 orbital motors/generators (9-33) with but not limited to: 4 gyroscopes (19-43) attached to each orbital motors/generators (9-33), for each rotor. There are 2 directional linear thrust pulses from each orbital motors/generators (9-33), for each revolution.

Therefore, there are 16 directional linear thrust pulses for each main rotor (15-39), 8 full cycle sine wave. With but not limited to: a 2 rotor design, there are 32 directional linear thrust pulses from all 16 orbital motors/generators (9-33), with the 4 gyroscopes (19-43) attached to each orbital motors/generators (9-33) for each revolution when 2 main rotors (15-39) combined.

The central computers (25-49) time but not limited to: main rotors (15-39) to each engage at the same time as to cancel each other's torque out and not produce any twisting in the vehicle. Therefore, but not limited to: there are still an 8 full cycle sine wave, directional linear thrust pulses, per one 360 degree rotation of the main rotors (15-39).

The directional linear thrust pulses are considered power pulses. 1 revolution per minute=32 power pulses per minute. 10 revolution per minute=320 power pulses per minute, 5.33 power pulses per second. 100 revolution per minute=3,200 power pulses per minute, 53.33 power pulses per second.

So, when the AAMD produces a 12:00 directional linear thrust. The 90 minute operation window the central computers (25-49) calculate to produce a smooth, constant directional linear thrust. By means of the timing, when one orbital motors/generators (9-33) is leaving the 90 minute operation window, another orbital motors/generators (9-33) is entering the 90 minute operation window.

This produces a smooth, constant push-pull from the AAMD, when operating at any power pulses per minute power level. The greater the angular velocity of the main rotors (15-39), and/or orbital motors/generators (9-33) and/or the gyroscopes (19-43) the greater the power output from the AAMD.

Similar to an internal combustion engine power stroke, by increasing the engine power strokes per minute, an increase in available horsepower from the engine. Increase the AAMD power pulses per minute, an increase in available directional linear thrust from the AAMD.

As the angular velocity increase in the main rotors (15-39), the central computers (25-49) must increase the orbital motors/generators (9-33) angular velocity to maintain the gyroscopes (19-43) in an outward direction away from the orbital motors/generators (9-33) axis, by means of the gyroscope pivot points (50-51) and the gyroscopes (19-43) stay in their maximum diameter.

The central computers (25-49) maintains this equilibrium of the greater angular velocity from the main rotors (15-39) and by control means regulates the angular velocity of the orbital motors/generators (9-33) as to but not limited to: provide enough angular velocity of the orbital motors/generators (9-33) to preserve the capability for the gyroscopes (19-43) stay in their maximum diameter, as the increased outward force from the greater angular velocity of the main rotors (15-39).

By means of the central computers (25-49) maintaining this equilibrium between the main rotors (15-39) and the orbital motors/generators (9-33), allows the central computers (25-49) to precisely engage and disengage the gyroscopes (19-43) and counter weights (52-53). By control means of the gyroscope positioning sensors (58) and gyroscope positioning pickups (59), linear motors for counter weights and gyroscopes (60), counter weight positioning sensors (61), counter weight positioning pickups (62), linear motor for gyroscopes (63), capacitor/electrical energy source for linear motor for gyroscopes (64) and the capacitor/electrical energy source for linear motors for counter weights (65).

When a 12:00 directional linear thrust is desired, the central computers (25-49) will but not limited to: engage the orbital motors/generators (9-33) on the clockwise rotating main rotor (15-39) at 5:15 to operate as a generator. Then engage the orbital motors/generators (9-33) on the counter clockwise rotating main rotor (15-39) at 6:45 to operate as a generator.

The central computers (25-49) will but not limited to: engage the orbital motors/generators (9-33) on the clockwise rotating main rotor (15-39) at 11:15 to operate as a motor. Then engage the orbital motors/generators (9-33) on the counter clockwise rotating main rotor (15-39) at 12:45 to operate as a motor.

This method can also be introduced.

When a 12:00 directional linear thrust is desired, the central computers (25-49) will but not limited to: engage the orbital motors/generators (9-33) on the clockwise rotating main rotor (15-39) at 5:15 to operate as a motor. Then engage the orbital motors/generators (9-33) on the counter clockwise rotating main rotor (15-39) at 6:45 to operate as a motor.

The central computers (25-49) will but not limited to: engage the orbital motors/generators (9-33) on the clockwise rotating main rotor (15-39) at 11:15 to operate as a motor. Then engage the orbital motors/generators (9-33) on the counter clockwise rotating main rotor (15-39) at 12:45 to operate as a motor.

When a 12:00 directional linear thrust is desired, on the clockwise rotating main rotor (15-39) at 5:15 the central computers (25-49) will engage the linear motor for gyroscopes (63) by means of the capacitor/electrical energy source for linear motor for gyroscopes (64).

Now the gyroscopes (19-43) will be ‘quickly forced outward’, away from the main rotors (15-39) radius by means of the gyroscope pivot points (50-51) and the gyroscopes (19-43) will change from their maximum diameter to their smaller diameter. The movement of the gyroscopes (19-43) will be completed by 6:45 on the clockwise rotating main rotor (15-39).

At the same time, the central computers (25-49) will engage the linear motor for counter weights (60) and the capacitor/electrical energy source for linear motor for counter weights (65) and begin to move the counter weights (52-53) inward, towards the on the main rotor (15-39) axis at 5:15 while rotating clockwise. The movement of the counter weights (52-53) will be completed by 6:45 on the clockwise rotating main rotor (15-39).

When a 12:00 directional linear thrust is desired, on the counter clockwise rotating main rotor (15-39) at 6:45 the central computers (25-49) will engage the linear motor for gyroscopes (63) by means of the capacitor/electrical energy source for linear motor for gyroscopes (64).

Now the gyroscopes (19-43) will be ‘quickly forced outward’, away from the main rotors (15-39) radius by means of the gyroscope pivot points (50-51) and the gyroscopes (19-43) will change from their maximum diameter to their smaller diameter.

The movement of the gyroscopes (19-43) will be completed by 5:15 on the counter clockwise rotating main rotor (15-39). The gyroscopes (19-43) position is held in place by means of the central computers (25-49) and the magnetic locking system built into the linear motors for gyroscopes (63).

The timing of the release of the magnetic locking system built into the linear motors for gyroscopes (63) are controlled by means of the central computer (25-49). The central computer (25-49) can follow the order of the engagements timing mentioned previously, but not limited to: and engage and disengage the magnetic locking system built into the linear motors for gyroscopes (63) independently from all other components.

At the same time, the central computers (25-49) will engage the linear motor for counter weights (60) and the capacitor/electrical energy source for linear motor for counter weights and begin to move the counter weights (52-53) inward, towards the on the main rotor (15-39) axis at 6:45 while rotating counter clockwise.

The movement of the counter weights (52-53) will be completed by 5:15 on the counter clockwise rotating main rotor (15-39). The counter weights (52-53) position is held in place by means of the central computers (25-49) and the magnetic locking system built into the linear motors for counter weights and gyroscopes (60).

The timing of the release of the magnetic locking system built into the linear motors for counter weights and gyroscopes (60) are controlled by means of the central computer (25-49). The central computer (25-49) can follow the order of the engagements timing or but not limited to: and engage and disengage the magnetic locking system built into the linear motors for counter weights and gyroscopes (60) independently from all other components.

On the other side of the main rotors (15-39).

When a 12:00 directional linear thrust is desired, on the clockwise rotating main rotor (15-39) at 11:15 the central computers (25-49) will disengage the locking system in the linear motor for gyroscopes (63) by control means.

The high angular velocity of the orbital motors/generators (9-33) and the gyroscopes (19-43) will be ‘quickly forced inward’ and spring back towards the main rotors (15-39) radius by means of the gyroscope pivot points (50-51) and the gyroscopes (19-43) will change from their smaller diameter to their maximum diameter.

The central computers (25-49) will but not limited to: engage the linear motor for gyroscopes (63) by control means and the capacitor/electrical energy source for linear motor for gyroscopes (64). The movement of the gyroscopes (19-43) will be completed by 12:45 on the clockwise rotating main rotor (15-39).

At the same time, the central computers (25-49) will engage the linear motor for counter weights and gyroscopes (60) and the capacitor/electrical energy source for linear motors for counter weights (64) and the capacitor/electrical energy source for linear motors for gyroscopes (65) and begin to move the counter weights (52-53) outward, away from the main rotor (15-39) axis at 11:15 while rotating clockwise. The movement of the counter weights (52-53) will be completed by 12:45 on the clockwise rotating main rotor (15-39).

When a 12:00 directional linear thrust is desired, on the counter clockwise rotating main rotor (15-39) at 12:45 the central computers (25-49) will disengage the locking system in the linear motor for gyroscopes (63) by control means.

The high angular velocity of the orbital motors/generators (9-33) and the gyroscopes (19-43) will be ‘quickly forced inward’, and spring back towards the main rotors (15-39) radius by means of the gyroscope pivot points (50-51) and the gyroscopes (19-43) will change from their smaller diameter to their maximum diameter.

The central computers (25-49) will but not limited to: engage the linear motor for gyroscopes (63) by control means and the capacitor/electrical energy source for linear motor for gyroscopes (64). The movement of the gyroscopes (19-43) will be completed by 11:15 on the counter clockwise rotating main rotor (15-39).

At the same time, the central computers (25-49) will engage the linear motor for counter weights (60) and the capacitor/electrical energy source for linear motors for counter weights (65) and begin to move the counter weights (52-53) outward, away from the main rotor (15-39) axis at 12:45 while rotating counter clockwise. The movement of the counter weights (52-53) will be completed by 11:15 on the counter clockwise rotating main rotor (15-39).

The central computers (25-49) data base has all the required calculations on all components within the AAMD. The central computers (25-49) will monitor and regulate the exact position of the gyroscopes (19-43) and counter weights (52-53) by control means, as to always maintain a perfectly balanced main rotors (15-39) at all times while the AAMD is operating.

The mass of the gyroscopes (19-43) and counter weights (52-53) are perfectly calibrated by means of the central computers (25-49) and as the main rotors (15-39) rotate with the gyroscopes (19-43) and counter weights (52-53) moving in and out, to and from the main rotors (15-39) radius, the central computers (25-49) will maintain the exact equilibrium of the mass from the main rotors (15-39) radius, allowing a perfectly balanced and smooth rotating main rotors (15-39) and cancels each other's action out at all times.

The central computers (25-49) providing balanced main rotors (15-39), with balanced mass, at all times. The directional linear thrust is by means of the resistant gyroscopic forces produced by means of the gyroscopes (19-43) moving quickly outward, away from the main rotors (15-39) radius, changing from a large diameter to a smaller diameter, as they stretch outward, by means of the gyroscope pivot points (50-51) by means of the linear motor for gyroscopes (63).

Then the directional linear thrust is by means of the resistant gyroscopic forces produced by means of the gyroscopes (19-43) moving quickly inward, and spring back towards the main rotors (15-39) radius, changing from the smaller diameter to the large diameter as they are pulled inward, by means of the gyroscope pivot points (50-51) and by means of but not limited to: the orbital motors/generators (9-33), linear motor for gyroscopes (63) and the capacitor/electrical energy source for linear motor for gyroscopes (64).

The movement of the gyroscopes (19-43) and counter weights (52-53) mass are calibrated, by means of the central computers (25-49) as to cancel each other out and provide zero directional linear thrust.

But since their masses are always in an equal state all around the main rotors (15-39), by means of the central computers (25-49), the gyroscopic forces produced by means of the gyroscopes (19-43) forced to move quickly. Provide an anchoring point for the AAMD to provide directional linear thrust.

When the orbital motors/generators (9-33) are at very high angular velocity, the gyroscopes (19-43) are also rotating at very high angular velocity. The gyroscopes (19-43) resist the quick movement and provide a solid like attaching device without any differential of mass around the main rotors (15-39).

So, the mass is always equal all around the main rotors (15-39) and the gyroscopes (19-43) provide a useable and controllable gyroscopic force that can be directed into a small section of the main rotors (15-39) to provide directional linear thrust.

The gyroscopes (19-43) follow a circular path around the main rotors (15-39) radius. When the orbital motors/generators (9-33) and the gyroscopes (19-43) are at very high angular velocity, they have a very high gyroscopic force potential within them.

The gyroscopes (19-43) want to follow a circular path around the main rotors (15-39) radius. When the gyroscopes (19-43) are forced to be moved towards the main rotors (15-39) radius by control means, the gyroscopes (19-43) ‘don't come back towards’ the main rotors (15-39) radius and follow a different path.

The gyroscopes (19-43) want to follow their own circular path, by means of their very high gyroscopic force potential and the main rotors (15-39) radius is ‘pulled towards’ the gyroscopes (19-43) and provides a directional linear thrust.

The gyroscopes (19-43) want to follow a circular path around the main rotors (15-39) radius. When the gyroscopes (19-43) are forced to be moved away from the main rotors (15-39) radius by control means, the gyroscopes (19-43) ‘don't push away’ the main rotors (15-39) radius and follow a different path.

The gyroscopes (19-43) want to follow their own circular path, by means of their very high gyroscopic force potential and the main rotors (15-39) radius is ‘push away’ from the gyroscopes (19-43) and provides a directional linear thrust.

This is unique capability for the AAMD to maintain a perfectly balanced main rotors (15-39) system, while having the capability to strategically timed rapid movement of the gyroscopes (19-43) enable the AAMD to produce a controllable, directional linear thrust.

One other means of operation but not limited to:

When the central computers (25-39) wants 12:00 directional linear thrust, when the central computers (25-39) engages the gyroscopes (19-43) by means of the linear motor for gyroscopes (63), in the 5:15-6:45 positions when the main rotors (15-39) are rotating in the clock wise direction and when the main rotors (15-39) are rotating in the counter clock wise direction, in the 6:45-5:15 positions.

When the central computers (25-39) wants 12:00 directional linear thrust, when the central computers (25-39) engages the gyroscopes (19-43) by means of the linear motor for gyroscopes (63), in the 11:15-12:45 positions when the main rotors (15-39) are rotating in the clock wise direction and when the main rotors (15-39) are rotating in the counter clock wise direction, in the 12:45-11:15 positions.

The central computers (25-39) can control each of the gyroscopes (19-43) by means of the linear motor for gyroscopes (63) independently. Then it can instruct the timing of the engagement of the gyroscopes (19-43) by means of the linear motor for gyroscopes (63) as to engage but not limited to: to engage one gyroscope (19-43) and one linear motor for gyroscopes (63) at a time.

This controlled and calculated timing in that manner, can produced a ‘simulated screw or propeller’ shaped gyroscopes by means of the 4 gyroscopes (19-43) being manipulated into a screw or propeller shape momentarily by control means of the central computers (25-39).

This method of operation would produce a ‘enabling an even smoother transition of the produced directional linear thrust from the AAMD.

The ‘gyroscopic screw’ would be but not limited to: the gyroscopes (19-43) being forced away from the main rotors (15-39) radius would be in a ‘simulated thread pattern’ of screwing out. The ‘gyroscopic screw’ would be but not limited to: the gyroscopes (19-43) being forced towards the main rotors (15-39) radius would be in a ‘simulated thread pattern’ of screwing in.

The AAMD would be using this advanced method of producing a momentary position to push or pull from and use the gyroscopic screw to produce a fully controllable directional linear thrust capability by means of the central computers (25-49).

If a 12:00 direction of linear thrust is desired, gyroscopic screw will begin at 5:15 in the clockwise rotating main rotor and 6:45 in the counter clockwise rotating rotor and gyroscopic screw will begin at 11:15 in the clockwise rotating main rotor and 12:45 in the counter clockwise rotating rotor.

The gyroscopic screw will end at 6:45 in the clockwise rotating main rotor and 5:15 in the counter clockwise rotating rotor and gyroscopic screw will end at 12:45 in the clockwise rotating main rotor and 11:15 in the counter clockwise rotating rotor.

If a snapshot of the gyroscopic screw was taken when the gyroscopes (19-43) are in but not limited to: the 5:15-6:45 and 11:15-12:45 operational window, the gyroscopes (19-43) would be configured into a ‘simulated’ thread shape outward thread and an inward thread. The gyroscopes (19-43) will but not limited to: be configured to look similar to a standard screw shape, with its standard thread and reverse thread design, by control means of the central computers (25-49).

The AAMD but not limited to: will use the gyroscopic screw method to propel the vehicle in any of the 360 degree around the vehicle and AAMD. Similar to how an aircraft uses propellers to push off the air as a medium.

The AAMD with its 3 different 90 degree differential of rotation of axis vectors enables the gyroscopic screw method to propel the vehicle without an external medium to push off of and still comply with all the laws of motion, due to the cancelation capability of directing the counter force to be deflected in a 90 degrees from the directional linear thrust and not 180 degrees, which would cancel out the propulsion capability.

To make the AAMD function properly to produce directional linear thrust, first the central computers (25-49) has the main rotors (15-39) operate at a predetermined speed. Then the speed is calculated by the rotor speed sensor (23-47) and the rotor speed sensors pick-ups (22-46), this information is distributed to the central computers (25-49), then the central computers (25-49) control the electrical input power to the main rotor coils (6-30).

Then angular velocity of the main rotors (15-39) must be significant enough to produce substantial centrifugal force at the outer edge of the main rotors (15-39). Then the central computers (25-39) also sets the but not limited to: predetermined speed of the 8 orbital motors/generators (9-33) within each main rotors (15-39).

By calculating the speed of the main rotors (15-39) and knowing their centrifugal force they produce, then the central computer (25-49) controls the electrical input power to the main rotor stator coils (8-32). The central computer (25-49) at the same time engages the small gyroscope motors/generators (18-42).

The angular velocity for which the main rotors (15-39) operate by means of central computers (25-49) as to control the simulated rotational gravity to the orbital motors/generators (9-33) and the gyroscopes (19-43). The angular velocity for which the 8 orbital motors/generators (9-33) operate by means of central computers (25-49) as to control the simulated rotational gravity to the gyroscopes (19-43).

The central computers (25-49) also monitor all gyroscopes by means of the gyroscope positioning sensors (58) and the gyroscope positioning pickup (59). The central computers (25-49) also monitor all counter weights (52-53) by means of the counter weight positioning sensors (61) and the counter weight positioning pickup (62).

This enables the central computers (25-49) to monitor all aspects of the AAMD functioning dynamics. Then the central computers (25-49) can control the movement of the counter weights (52-53) by means of but not limited to: linear motors for counter weights and gyroscopes (60) and capacitor/electrical energy source for linear motors for counter weights (65).

The central computers (25-49) monitor the exact location of the gyroscopes (19-43) and the counter weights (52-53) by said means as to maintain perfectly balanced main rotors (15-39) but not limited to: the entire duration the AAMD is operating.

By means of moving the counter weights (52-53) accordantly to back and forth, to and from the main rotors (15-39) axis, and compensate for the movement of mass of the gyroscopes (19-43) as they move back and forth, to and from direction of the main rotors (15-39) axis.

When the gyroscopes (19-43) move, in an outward direction away from the main rotors (15-39) axis, the central computers (25-49) will instruct the linear motors for counter weights and gyroscopes (60) to move the counter weights (52-53) in an inward direction towards the main rotors (15-39) axis.

By means of the central computers (25-49), gyroscope positioning sensors (58), gyroscope positioning pickup (59), linear motors for counter weights and gyroscopes (60), counter weight positioning sensors (61) and the counter weight positioning pickup (62), linear motor for gyroscopes (63), capacitor/electrical energy source for linear motor for gyroscopes (64) and the capacitor/electrical energy source for linear motors for counter weights (65).

When the gyroscopes (19-43) move, in an outward direction away from the main rotors (15-39) axis, the central computers (25-49) will instruct the linear motors for counter weights and gyroscopes (60) to move the counter weights (52-53) in an inward direction towards the main rotors (15-39) axis.

By means of the central computers (25-49), gyroscope positioning sensors (58), gyroscope positioning pickup (59), linear motors for counter weights and gyroscopes (60), counter weight positioning sensors (61), counter weight positioning pickup (62) and the capacitor/electrical energy source for linear motors for counter weights (65).

The central computers (25-49) also are programed the capability to have the projected movements of the gyroscopes (19-43) and the counter weights (52-53) movement and calculate their mass independently and anticipate their actions ahead of time and can but not limited to: move the counter weights (52-53) independently.

By means of the linear motors for counter weights and gyroscopes (60) and override if need be but not limited to: the gyroscope positioning sensors (58), gyroscope positioning pickup (59), linear motors for counter weights and gyroscopes (60), counter weight positioning sensors (61) and the counter weight positioning pickup (62).

This action allows for the smoothest and most accurately balanced main rotors (15-39) achievable. The AAMD can have longer operational life and lower structural strain on all the vehicles components with a completely smooth propulsion system. Also, the optimal balanced main rotors (15-39) can be able to generate higher overall output power by means of the ultra-smooth action of the AAMD.

Due to the extreme complexity of the Alternating Angular Momentum Drive (AAMD), it will be explained in more layman terms for this application. The AAMD was envisioned to replicate in theory, the method in which alternating current (AC) and the current periodically reverses its direction and is the most efficient means of transfer of electrical power today. This is compared to the lower efficient means of transferring electrical power, direct current (DC) which only flows in a single direction which cannot change periodically.

Today's propulsion systems function similar to the DC system, with its thrust only flows in a single direction. The AAMD functions with a push-pull concept, is similar in method to the alternating current time-varying oscillating sinusoidal waveform. Whereas there are gyroscopes (19-43) moved in a calculated manner to deliver a pulsed, 8 phase directional linear thrust, from a similar oscillating, alternating angular momentum waveform.

Then when the gyroscopes (19-43) are moved back in a calculated manner, to their original location, there is another pulse of directional linear thrust, in the same direction. Knowing that gyroscopes are affected by gravity, as they have mass, the greater the angular velocity of the gyroscopes, the less gravity has an effect on them.

For maximum efficiency, the entire system is controlled by but not limited to: 2-central computers (25-49) and they but not limited to: control, monitor, rotational direction and fine tune angular velocity of the main rotors (15-39), orbital motors/generators (9-33) and the gyroscopes (19-43) and all calculations required when the AAMD is operating, by means of a vast programed information data base, sensor and pickups throughout the AAMD. The AAMD is encased in a but not limited to: a vacuum sealed outer case (2-26).

The main rotors (15-39) are for the ease of understanding, gravity multipliers, with their angular velocity, rotational inertia, centrifugal force applied, etc. . . . There are but not limited to: 2 counter rotating main rotors (15-39) and there are but not limited to: permanent magnet main rotor motor/generator (5-29) and main rotor motor/generator coils (6-30) that supply input torque to turn the main rotors (15-39).

The angular velocity of the main rotors (15-39) can vary depending on the quantity of rotational simulated gravity (G's) are required from the AAMD, by means of the central computers (25-49) control.

This capability to alter and produce a computer calculated exact quantity, of rotational simulated gravity at the rim of the main rotors (15-39) is one of the elements in the functionality of the AAMD system. There are but not limited to: 8 orbital motors/generators (9-33) in each of the main rotors (15-39), 16 total orbital motors/generators (9-33) in the 2 counter rotating main rotors (15-39).

The orbital motors/generators (9-33) are also capable of variating their angular velocity and their rotational simulated gravity as well, by means of the central computers (25-49). The orbital motors/generators (9-33) can function as a motor or a generator when required and the angular velocity, direction of rotation and power level as in rate of angular velocity change in the motors or generators are fully controlled by means of the central computers (25-49).

Attached to each of the orbital motors/generators (9-33) are the gyroscopes motors/generators (16-40), the input torque that powers the large gyroscope motors/generators (16-40) by means of the orbital motors/generators (9-33) but not limited to: and/or the electrical input power can be used by means of the rotor coils (7-31) and main rotor stator coils (8-32).

The large gyroscope motors/generators (16-40) can function as a motor or a generator, by control means of the central computers (25-49). The large gyroscope motors/generators (16-40) can but not limited to: power the linear motors for gyroscopes (64) and linear motors for counter weights (65).

The large gyroscope motors/generators (16-40) can but not limited to: recharge the capacitor/electrical energy source for linear motors for gyroscopes (64) and the capacitor/electrical energy source for linear motors for counter weights (65) by control means of the central computers (25-49).

The engagement of the linear motors for gyroscopes (64), linear motors for counter weights (65), capacitor/electrical energy source for linear motors for gyroscopes (64) and the capacitor/electrical energy source for linear motors for counter weights (65) are fully controlled by means of the central computers (25-49) and allow accurate timing of the AAMD to function properly.

Also attached to each of the orbital motors/generators (9-33) and large gyroscope motors/generators (16-40) are the orbital motor/generator, gyroscope assembly connectors (17-41). Attached to each orbital motor/generator, gyroscope assembly connectors (17-41) are but not limited to:

4 gyroscopes (19-43), each gyroscopes (19-43), has but not limited to: a small gyroscope motors/generators (18-42), which but not limited to: can also function as a motor or generator, by means of control with their built in remote sensors into the small gyroscope motors/generators (18-42).

This enables the central computers (25-49), to fully control the direction of the rotation; the angular velocity and the rate of change of annular velocity in either the motor or generator mode, within each of the gyroscopes (19-43) independently.

Between the small gyroscope motors/generators (18-42) and the gyroscopes (19-43) there are the gyroscope pivot points (50-51). The gyroscope pivot points (50-51) enable the gyroscopes (19-43) to freely move back and forth independent from the small gyroscope motors/generators (18-42).

The orbital al motors/generators (9-33) and/or the large gyroscope motors/generators (16-40) supply's the input torque to turn the 4 gyroscopes (19-43) that are connected to each orbital motor/generator, gyroscope assembly connector (17-41) and all 4 gyroscopes (19-43) function as one large gyroscope due to all 4 gyroscopes (19-43) are rotating as one rotor, with each 4 gyroscopes (19-43) having their own gyroscope pivot points (50-51).

The electrical power from the large gyroscope motors/generators (16-40) powers the 4 small gyroscopes motors/generators (18-42) and allows the 4 gyroscopes (19-43) to rotate. The 4 gyroscopes (19-43) are connected to each of the orbital motors/generators (9-33) by means of the orbital motor/generator, gyroscope assembly connector (17-41).

There are but not limited to: 8 orbital motors/generators orbital motors/generators (9-33) and 32 gyroscopes (19-43) per main rotor (15-39). There are but not limited to: 2 counter rotating main rotors (15-39), 16 orbital motors/generators (9-33) and 64 gyroscopes (19-43) total per AAMD.

Each gyroscope (19-43) is connected to its own gyroscope pivot points (50-51). The gyroscope pivot points (50-51) permits each gyroscope (19-43) to move slightly inward and outward from but not limited to: from the main rotors (15-39) radius.

The 4 gyroscopes (19-43) also have the ability to alter their angular velocity, independently by means of the central computers (25-49). This enables the capability to control the angular velocity of the rotors in gyroscopes (19-43), angular momentum along its axis, calculated stored kinetic energy potential, precessional torque produced and the torque produced is perpendicular to the angular momentum vector, within each gyroscope.

A gyroscopic torque will result if the axis of a gyroscope is rotated and it acts perpendicular to the rotor axis and the magnitude of the torque is the product of the gyroscopes rotor moment of inertia, the angular velocity and the angular velocity of the gyroscopes axis.

The high angular velocity of the rotor within the gyroscopes (19-43), produces torque on the center of mass, which provides the change in angular momentum. The torque produced is perpendicular to the angular momentum vector.

The centers of mass of the gyroscopes (19-43), are placed on the gyroscope pivot points (50-51) and concentrate the center of mass in that one location when the gyroscopes (19-43), are operating. The center of mass in the gyroscopes (19-43), acts as a single partial in each gyroscope (19-43).

To have balanced rotors in any spinning device, here is a need to have all mass at the rim is equal and exact distance from the radius, and all other aspect must be exactly equal as well. Alter the mass at one location on a rotor or extend or shorten the distance from the radius and there is an unbalanced rotor.

Rotating an unbalanced rotor produces a pulsating and erratic movement with zero directional linear thrust capability. For a smooth rotational movement of the rotor, all regional of the rotor must be equal in mass and distance from the radius.

Within the gyroscope assembly (57) there are the gyroscope positioning sensors (58), gyroscope positioning pickups (59) linear motors for counter weights and gyroscopes (60), counter weight positioning sensors (61), counter weight positioning pickups (62), linear motor for gyroscopes (63), capacitors/electrical energy source for linear motor for gyroscopes (64), capacitors/electrical energy source for linear motor for gyroscopes (65), and they are all monitored and controlled by means of the central computers (25-49).

When the gyroscopes (19-43) move inward and outward from but not limited to: from the main rotors (15-39) radius, by means of the gyroscope pivot points (50-51). The main rotors (15-39) will experience an unbalanced rotor situation.

To enable fully balanced main rotors (15-39), the central computers (25-49) will monitor the movement of the gyroscopes (19-43), by means of the gyroscope positioning sensors (58), gyroscope positioning pickups (59).

Then the central computers (25-49) will instruct the linear motors for counter weights and gyroscopes (60) to move the counter weights (52-53) either towards or away from but not limited to: from the main rotors (15-39) radius, and control the exact movement of the counter weights (52-53) by means of the counter weight positioning sensors (61), counter weight positioning pickups (62).

The central computers (25-49) have the ability to know the exact movement of mass of the gyroscopes (19-43) to and from the main rotors (15-39) radius. The central computers (25-49) have the ability to know the exact movement of mass of the counter weights (52-53) to and from the main rotors (15-39) radius.

With this information within the central computers (25-49) and the control means of the gyroscopes (19-43) and counter weights (52-53), enable the central computers (25-49) to monitor and control the exact balance of the main rotors (15-39), while the gyroscopes (19-43) mass moves but not limited to: from the inner most position of the main rotors (15-39) radius, to the outer most position of the main rotors (15-39) radius.

When the gyroscopes (19-43) mass moves away from the main rotors (15-39) radius, the central computers (25-49) will instruct the linear motors for counter weights and gyroscopes (60) to move the counter weights (52-53) in the exact opposite direction, towards the main rotors (15-39) radius.

At the movement the gyroscopes (19-43) mass away from the main rotors (15-39) radius, there is an exact calculation/s the central computers (25-49) know in their data base. As the movement of the counter weights (52-53) mass moves towards the main rotors (15-39) radius, there is an exact calculation/s the central computers (25-49) know in their data base.

These known information calculations, by means of the central computers (25-49), enables the central computers (25-49) to precisely monitor and calculate the entire range of movement of the gyroscopes (19-43) mass, moving away from the main rotors (15-39) radius.

These known information calculations, by means of the central computers (25-49), enables the central computers (25-49) to precisely monitor and calculate the entire range of movement of the counter weights (52-53) mass, moving towards the main rotors (15-39) radius.

Then the central computers (25-49) can move the counter weights (52-53) mass towards the main rotors (15-39) radius, in a calculated precise manner with all applied but not limited to: centripetal and centrifugal forces calculations, as to provide a perfectly balanced main rotors (15-39) during the entire duration of the AAMD operation.

These known information calculations, by means of the central computers (25-49), enables the central computers (25-49) to precisely monitor and calculate the entire range of movement of the gyroscopes (19-43) mass moving towards the main rotors (15-39) radius.

These known information calculations, by means of the central computers (25-49), enables the central computers (25-49) to precisely monitor and calculate the entire range of movement of the counter weights (52-53) mass moving away from the main rotors (15-39) radius.

Then the central computers (25-49) can move the counter weights (52-53) mass away from the main rotors (15-39) radius, in a calculated precise manner with all applied but not limited to: centripetal and centrifugal forces calculations, as to provide a perfectly balanced main rotors (15-39) during the entire duration of the AAMD operation.

The central computers (25-49) by means of control, enable all aspects of the main rotors (15-39), to stay completely equal and provide perfectly balanced main rotors (15-39), the entire duration of the movement of the full range of motion of the gyroscopes (19-43) when they move from their inner most position to the outer most position compared to the main rotors (15-39) radius.

By means of gyroscope positioning sensor (58) and the gyroscope positioning pickup (59), linear motor for gyroscopes (63) and the capacitors/electrical energy source for linear motor for gyroscopes (64).

The central computers (25-49) by means of control, enable all aspects of the main rotors (15-39), to stay completely equal and provide perfectly balanced main rotors (15-39), the entire duration of the movement of the full range of motion of the counter weights (52-53) when they move from their inner most position to the outer most position compared to the main rotors (15-39) radius.

By means of the linear motors for counter weight (60), counter weight positioning sensor (61), counter weight positioning pickups (62) and the capacitors/electrical energy source for linear motors for counter weights (65).

This ability for totally balanced main rotors (15-39), when rotating and the understanding of fully maintaining balanced main rotors (15-39), at all times, that are one of the key elements of the functionality of the AAMD when the entire system is operational.

To assist in the understanding of the working dynamics of the AAMD with it 3 different spin directions and angular momentum vectors 90 degrees apart from one another. First, the main rotors (15-39), the second, the orbital motors/generators (9-33), the third, the gyroscopes (19-43), the system will be operated slowly at first.

The 90 degree separation from each other's vectors and angular velocity is similar to how in nature, the natural occurrence and is another key element that allows the AAMD to provide directional linear thrust and comply with all the laws of motion.

When a force is applied to a rotating object, it's rotation is changed and the movement of the object is 90 degrees ahead of the rotation. The force of gravity creates a torque on the object and this is the behavior with angular momentum and the torque produced.

What enables the AAMD to provide directional linear thrust capability is by the means of the 3 different spin directions and angular momentum vectors. The main rotors (15-39) and the orbital motors/generators (9-33) rotate at 90 degrees from each other's axis of rotation.

The orbital motors/generators (9-33) and the gyroscopes (19-43) also rotate at 90 degrees from each other's axis of rotation. This produces but not limited to: 180 degree deferential angular momentum vectors.

The 180 degree deferential angular momentum vectors enable the AAMD to produce calculated, short burst of directional gyroscopic force by means of the gyroscopes (19-43) moving, from their originally located distance from the main rotors (15-39) radius to and outward location, a greater distance from the main rotors radius (15-39).

When this takes place, due to the rotational dynamics of the 180 degree deferential angular momentum vectors, the deflective force enables the AAMD to use this slight momentary burst of deflective force and gyroscopic force as a tractive devise to “pull” or “push” to or from an producing a medium of something to “grasp” on to. Pushing and Pulling on the main rotors shaft (4-28) to produce directional linear thrust without interacting with an external medium.

The counter force produced which is equal and opposite the deflective force will be at 90 degrees from the directional thrust on both counter rotating main rotors (15-39).

If the calculated, directional deflective force was in the, but not limited to: 12:00 position. The counter force produced would be in the 3:00 and 9:00 position in the main rotors (15-39), cancelling out each out while producing a directional linear thrust capability.

The counter force produced which is equal and opposite the deflective force will be at 90 degrees from the directional thrust on both counter rotating main rotors (15-39). If the calculated, directional deflective force was in the, but not limited to: 6:00 position. The counter force produced would be in the 9:00 and 3:00 position in the main rotors (15-39), cancelling out each out while producing a directional linear thrust capability.

The gyroscopic forces produced from the gyroscopes (19-43) are by means of the rate of change of angle. If moved it slowly, it is relatively easy to move. If moved quickly, it will resist moving very powerfully. The extremely quick movement of the gyroscopes (19-43) by means of the orbital motors/generators (9-33), linear motor for gyroscopes (63) and the main rotors (15-39) can produce a ‘substantial’ amount of torque.

A spinning gyroscope stores energy proportional to its moment of inertia and the square of its angular velocity. Just as force is defined as the rate of change of linear momentum, torque is defined as the rate of change of an object's angular momentum

This large gyroscopic torque produced by means of the gyroscopes (19-43) moving quickly ‘to’ and ‘from’ their naturally rotating location around the orbital motors/generators (9-33) and main rotors (15-39), by means of the gyroscope pivot points (50-51) and the but not limited to: torque-induced precession, if the orbital motors/generators (9-33) are rotating in a but not limited to:

A precessional direction by means of the central computers (25-49) with the centripetal and centrifugal forces calculations combined with the applied rotational simulated gravity by means of the orbital motors/generators (9-33) and main rotors (15-39)

With no torque-induced precession, if the orbital motors/generators (9-33) are rotating in an anti precessional direction by means of the central computers (25-49) with the centripetal and centrifugal forces calculations combined with the applied rotational simulated gravity by means of the orbital motors/generators (9-33) and main rotors (15-39).

The centripetal and centrifugal forces calculated balanced main rotors (15-39) cancel each other out, by means of the counter weights (52-53), and provide smooth turning main rotors (15-39) while providing a small impulse of directional linear thrust.

The gyroscopic torque by means of the highly energetic gyroscopes (19-43) far exceeds their mass torque, with their torque-induced precession, centripetal and centrifugal forces force applied, from the axis of rotation in the main rotors (15-39).

Therefore, the total combined gyroscopic torque produced by means of the gyroscopes (19-43) when subjected to a high rotational simulated gravity, by means of the orbital motors/generators (9-33) and main rotors (15-39) is very high and is capable of producing a very high directional linear force to the main rotors main shafts (4-28).

The main rotors (15-39), orbital motors/generators (9-33), gyroscope motors/generators (18-42) and the gyroscopes (19-43) are capable of rotating in either direction, at any angular velocity and any acceleration and deceleration in angular velocity, independent to each other, by means of the central computers (25-49) control.

The central computers (25-49) contain all the applied forces information produced from this complicated matrix of rotating masses. The main rotors (15-39) angular velocity will be calculated by means of the central computer (25-49) and the calculated applied rotational simulated gravity will be produced by means of the main rotors (15-39) angular velocity.

The directional force of the produced rotational simulated gravity by means of the main rotors (15-39), is 90 degrees from the direction of the force of gravity when sitting level on earth at sea-level. This entails the earth's gravity will be in but not limited to: the same direction as the main rotors (15-39) axis of rotation.

The rotational simulated gravity produced by means of the main rotors (15-39), will be in the direction of the main rotors (15-39) plane, 90 degrees from the main rotors (15-39) axis of rotation, towards the outer rim of the main rotors (15-39).

If the orbital motors/generators (9-33) are rotating in a but not limited to: a precessional direction by means of the central computers (25-49), the gyroscopic precession is 90 degrees from the rotors axis of rotation, by means of gyroscopic forces acting on the spinning rotor, the lift forces of the rotor actually occur 90 degrees later, in front of where the input force to was applied to the rotor. This is called gyroscopic precession or torque induced precession.

There is a correlation between a force applied on a gyroscope and the subsequent force due to precession. The larger the rigidity of a gyroscope, the more difficult it is to cause precession, and the less precession there will be for a given force. There are a number of reasons for the rigidity of a gyroscope: the distance of the mass to the axis of rotation, angular velocity and the mass of the rotor.

The precession angular velocity is inversely proportional to the spin angular velocity. The angular velocity of precession increases as the mass applied is increased. Therefore, doubling the mass, doubles the angular velocity of precession.

This is where but not limited to: the rotational simulated gravity is applied from the main rotors (15-39), orbital motors/generators (9-33) and the gyroscopes (19-43) comes into play. When the orbital motors/generators (9-33) have a high angular velocity, they produce a rotational simulated gravity capability to the gyroscopes (19-43).

The orbital motors/generators (9-33) rotational simulated gravity can be used in effect but not limited to: a ‘switching mechanism’ to turn on and turn off the rotational simulated gravity produced by means of the main rotors (15-39).

The switching mechanism will not be an on-off in an instant procedure. Instead it will be a progression of rate of change in the angular velocity of the orbital motors/generators (9-33) and how quickly they speed up or slow down rotational speed.

This switching capability is by means that the central computers (25-49) has the means to calculate all combined torque-induced precession, centripetal and centrifugal forces force applied, applied in the main rotors (15-39), orbital motors/generators (9-33) and gyroscopes (19-43).

The central computers (25-49) can calculate the angular velocity of the orbital motors/generators (9-33) as to have their rotational simulated gravity applied to the gyroscopes (19-43) but not limited to: surpass the rotational simulated gravity produced by means of the main rotors (15-39) applied to the gyroscopes (19-43), when required.

The central computers (25-49) can calculate the angular velocity of the orbital motors/generators (9-33) as to have their rotational simulated gravity applied to the gyroscopes (19-43) but not limited to: fall below the rotational simulated gravity produced by means of the main rotors (15-39) applied to the gyroscopes (19-43), when required.

The central computers (25-49) can increase or decrease the rotational simulated gravity produced by means of the main rotors (15-39) and this but not limited to: be how the central computers (25-49) and manage and control output power from minimum to maximum directional linear thrust available from the AAMD.

Therefore, when the orbital motors/generators (9-33) have a high angular velocity, the gyroscopes (19-43) follow the orbital motors/generators (9-33) high rotational simulated gravity and stay at a closer distance from the main rotors (15-39) axis by means of the gyroscope pivot points (50-51).

When the orbital motors/generators (9-33) have a low angular velocity, the gyroscopes (19-43) follow the main rotors (15-39) high rotational simulated gravity and begin to move further away from the distance of the main rotors (15-39) axis by means of the gyroscope pivot points (50-51).

Another way to explain what is happening. When the orbital motors/generators (9-33) are rotating quickly, the gyroscopes (19-43) are subjected to their higher rotational simulated gravity than the lower rotational simulated gravity produced by means of the main rotors (15-39).

Then follow the rotational path of the gyroscopes (19-43) in the maximum diameter by means of the gyroscope pivot points (50-51) and they do not follow the main rotors (15-39) outward force by means of their lower rotational simulated gravity produced.

Also, another way to explain what is happening. When the orbital motors/generators (9-33) are rotating slowly, the gyroscopes (19-43) are subjected to the higher rotational simulated gravity produced by means of the main rotors (15-39) and not the reduced rotational simulated gravity produced by means of the orbital motors/generators (9-33).

The gyroscopes (19-43) will now extend in an outward direction away from the main rotors (15-39) axis with a reduce diameter by means of the gyroscope pivot points (50-51) and the linear motor for gyroscopes (63) and follow the main rotors (15-39) outward force by means of their higher rotational simulated gravity produced, than the lower rotational simulated gravity produced by means of the orbital motors/generators (9-33).

Therefore, the gyroscopes (19-43) are but not limited to: subjugated to follow the orbital motors/generators (9-33) forces when the orbital motors/generators (9-33) are operating at high angular velocity and disregard the main rotors (15-39) forces.

Then, the gyroscopes (19-43) are subjugated to follow the main rotors (15-39) forces and disregard the orbital motors/generators (9-33) forces when the orbital motors/generators (9-33) are operating at a lower angular velocity. This is the essence of the On and Off rotational simulated gravity switch.

When the orbital motors/generators (9-33) angular velocity is high, the gyroscopes (19-43) are in their maximum diameter from the orbital motors/generators (9-33) rotation of axis, by means of the Gyroscope pivot points (50-51). When the orbital motors/generators (9-33) angular velocity has been reduced.

By means of the orbital motors/generators (9-33) functioning as generators, the rotational simulated gravity produced by means of the main rotors (15-39), overcome the rotational simulated gravity of the orbital motors/generators (9-33).

When this transpires, the gyroscopes (19-43) but not limited to: move outward away from the main rotors (15-39) axis by means of the linear motor for gyroscopes (63) and the gyroscopes (19-43) begin to reduce from their maximum diameter to a smaller diameter by means of the Gyroscope pivot points (50-51) and the reduced angular velocity of the orbital motors/generators (9-33).

The gyroscopes (19-43) angular velocity, direction of rotation of their rotors and intensity can also be fully controlled by means of the central computers (25-49). This produces a resistance to change of direction and rigidity of the gyroscopes (19-43).

On the clockwise rotating main rotor (15 or 39), if the directional linear thrust is but not limited to: directed towards the 12:00 position by means of the central computers (25-49), they will monitor the main rotors (15-39) positions, by means of the main rotor sensor (22-46) and main rotor sensor pickup (23-47). This explained procedure will be for just one of the 8 orbital motors/generators (9-33) and the main rotor (15 or 39) rotating clockwise.

When the orbital motors/generators (9-33) reach but not limited to: the 5:15 position. They are rotating at a predetermined high angular velocity, which calculations are by means of the central computers (25-49), main rotor sensor (22-46) and main rotor sensor pickup (23-47).

The gyroscopes (19-43) angular velocity can also predetermined which calculations are by means of the main rotor sensor (22-46) and main rotor sensor pickup (23-47) and controlled by means of the gyroscope motors/generators (18-42) with built-in remote sensor and controller and controlled by mean of the central computers (25-49).

At but not limited to: the 5:15 position, the central computers (25-49) will engage the orbital motors/generators (9-33) to begin to function a generator and the stored kinetic energy within the orbital motors/generators (9-33) and all components connected, are converted into an electrical output power, by means of the orbital motors/generators (9-33).

The central computers (25-49) can calculate the angular velocity of the orbital motors/generators (9-33) as to have their rotational simulated gravity but not limited to: surpass the rotational simulated gravity produced by means of the main rotors (15-39), when required.

The central computers (25-49) can calculate the angular velocity of the orbital motors/generators (9-33) as to have their rotational simulated gravity but not limited to: fall below the rotational simulated gravity produced by means of the main rotors (15-39), when required.

When the orbital motors/generators (9-33) to function a generator, quickly their angular velocity and rotational simulated gravity produced from the orbital motors/generators (9-33) is reduced. Enables the rotational simulated gravity from the main rotors (15-39), to overtake the rotational simulated gravity produced from the orbital motors/generators (9-33) with the and by means of the linear motor for gyroscopes (63).

The gyroscopes (19-43) will be ‘forced to move away’ from the main rotors rotation of axis (4-28), by means of the Gyroscope pivot points (50-51) and but not limited to: all the precessional, centripetal and centrifugal forces applied.

The mechanical input power from the orbital motors/generators (9-33) stored kinetic energy, when functioning as a generator, the orbital motors/generators (9-33) will now have a reduced angular velocity and all the gyroscopic, centripetal and centrifugal forces applied.

Now the high angular velocity by means of the main rotors (15-39) and the linear motor for gyroscopes (63) overpowers the gyroscopes (19-43) and the gyroscopes (19-43) rotational diameter begin to be reduced by means of the Gyroscope pivot points (50-51) as they move in an outward direction, away from the main rotors (15-39) axis.

When this occurs, there is a relationship of the torque produced by the gyroscopes (19-43) and is determined by the rate of change of their total angular momentum. Therefore, there is a torque applied to the system at 90 degrees from the gyroscopes (19-43) position in relationship to the main rotors (15-39) rotation position.

When the orbital motors/generators (9-33) are in the 5:15 position, in the clockwise rotating main rotor (15 or 39) the produced dynamic braking action by means of the orbital motors/generators (9-33) functioning as a generator, applies but not limited to: a torque at 90 degrees from the 5:15 position to the 6:45 position, 6:00 average, and the counter torque to be in either the 3:00 or 9:00 average position, depending on the direction of rotation, in the orbital motors/generators (9-33).

This action produces a directional linear thrust 90 degrees from the torque by means of the orbital motors/generators (9-33) functioning as a generator and this directional linear thrust it is in the 12:00 position, average.

This action producing a “pushing” action on main rotors main shaft (4-28), by means of but not limited to: linear motor for gyroscopes (63), all the precessional, gyroscopic, centripetal and centrifugal forces applied, with the linear motor for gyroscopes (63) repositions the gyroscopes (19-43) and ‘forcing’ the main rotors main shaft (4-28), to be ‘pushed’ away from the orbital path of the rotation of the gyroscopes (19-43).

This action will occur when the orbital motors/generators (9-33) proceed from but not limited to: 5:15 to 6:45, 6:00 average in the clockwise rotating rotor (15 or 39) and apply directional linear thrust it is in the 11:15 to 12:45 positions, 12:00 average accordingly. This action will occur when all the orbital motors/generators (9-33) go through the mentioned procedure when the main rotor (15-39) is rotating clockwise.

The timing of the orbital motors/generators (9-33) that was in the 5:15-6:45 position on the clockwise main rotor (15 or 39) to produce directional linear thrust, will now be in the 6:45-5:15 position on the counter rotating main rotor (15 or 39) and apply directional linear thrust it is in the 12:45 to 11:15 positions accordingly. The exact opposite of the clockwise main rotor (15 or 39) and cancel each other's forces out for a smooth running system.

On the other side of the clockwise rotating main rotor (15 or 39) when the directional linear thrust is still at but not limited to: the 12:00 position, the central computers (25-49) will monitor the main rotors (15 or 39) positions, by control means.

This explained procedure but not limited to: will be for just one of the 8 orbital motors/generators (9-33) and the main rotor (15 or 39) rotating clockwise. When the orbital motors/generators (9-33) reach but not limited to: the 11:00 position. They are rotating at a predetermined low angular velocity, which calculations are by means of the central computers (25-49), main rotor sensor (22-46) and main rotor sensor pickup (23-47).

The gyroscopes (19-43) angular velocity can also predetermined which calculations are by means of the main rotor sensor (22-46) and main rotor sensor pickup (23-47) and controlled by means of the gyroscope motors/generators (18-42) with built-in remote sensor and controller and controlled by the central computers (25-49).

At but not limited to: the 11:15 position, the central computers (25-49) will engage the orbital motors/generators (9-33) to function a motor and quickly increase the angular velocity of the orbital motors/generators (9-33) and the electrical input is from the rotor coils (7-31) and main rotor stator coils (8-32)

The electrical output by means of the orbital motors/generators (9-33) to function a generator at but not limited to: the 5:15 position. The produced output electrical power is controlled by means of the power controller for the main rotor stators (54-55) and combined with the rotor coils (7-31) and the main rotor stator coils (8-32) and controlled by means of the central computer (25-39).

With their combined electrical power controlled by means of the power controller for the main rotor stators (54-55). The electrical output by means of the orbital motors/generators (9-33) to functioning as a generator, is diverted to the electrical input by means of the power controller for the main rotor stators (54-55), into the orbital motors/generators (9-33) functioning as a motor.

The central computers (25-49) can calculate the angular velocity of the orbital motors/generators (9-33) as to have their rotational simulated gravity but not limited to: surpass the rotational simulated gravity produced by means of the main rotors (15-39), when required.

The central computer can calculate the angular velocity of the orbital motors/generators (9-33) as to have their rotational simulated gravity but not limited to: fall below the rotational simulated gravity produced by means of the main rotors (15-39), when required.

The increased angular velocity and rotational simulated gravity produced from the orbital motors/generators (9-33) will enable the rotational simulated gravity from the orbital motors/generators (9-33) to overtake the rotational simulated gravity produced from the main rotors (15-39), and with the linear motor for gyroscopes (63).

The gyroscopes (19-43) will be ‘forced to move back inward’ towards the main rotors rotation of axis (4-28), by means of the Gyroscope pivot points (50-51) and the electrical input to the orbital motors/generators (9-33) functioning as a motor.

The increased angular velocity of the orbital motors/generators (9-33) functioning as a motor, plus the linear motor for gyroscopes (63), ‘force’ the gyroscopes (19-43) back into their maximum diameter, from the smaller diameter, by means of the Gyroscope pivot points (50-51).

The mechanical input power from the orbital motors/generators (9-33) functioning as a motor, plus the linear motor for gyroscopes (63), overpowers the resistive gyroscopic, centripetal and centrifugal forces applied and assisted by means of the linear motor for gyroscopes (63) resets the gyroscopes (19-43) back to their maximum diameter by means of the Gyroscope pivot points (50-51) as they move back in, towards the inward direction of the main rotors axis (4-28).

When this occurs, there is a relationship of the torque produced by the gyroscopes (19-43) and is determined by the rate of change of their total angular momentum. Therefore, there is torque applied to the system at 90 degrees from the gyroscopes (19-43) position in relationship to the main rotors (15-39) rotation position.

When the orbital motors/generators (9-33) are in the 11:15 position, in the clockwise rotating main rotor (15 or 39) the produced motor action produced action by means of the orbital motors/generators (9-33) functioning as a motor, applies but not limited to: a torque at 90 degrees from the 11:15 position to the 12:45 position, 12:00 average, and the counter torque to be in either the 3:00 or 9:00 average position, depending on the direction of rotation, in the orbital motors/generators (9-33).

This action produces a directional linear thrust 90 degrees from the torque by means of the orbital motors/generators (9-33) functioning as a motor and this directional linear thrust it is in the 12:00 position. This action producing a “pulling” action on main rotors main shaft (4 or 28), by means of but not limited to: the linear motor for gyroscopes (63), resistive precessional, gyroscopic, centripetal and centrifugal forces applied by the repositioning the gyroscopes (19-43) and ‘forcing’ the main rotors main shaft (4 or 28) to be ‘pulled’ towards the orbit of the rotation of the gyroscopes (19-43).

This action will occur when the orbital motors/generators (9-33) proceed from but not limited to: 11:15 to 12:45, with a 12:00 average position, in the clockwise rotating rotor (15 or 39) and apply directional linear thrust it is in the 11:15 to 12:45 positions accordingly, with a 12:00 average position. This action will occur when all the orbital motors/generators (9-33) go through the mentioned procedure when the main rotor (15 or 39) is rotating clockwise.

The timing of the orbital motors/generators (9-33) that was in the 11:15-12:45 position on the clockwise main rotor (15 or 39) to produce directional linear thrust and will be in the 12:45-11:15 position with a 12:00 average position, on the counter rotating main rotor (15 or 39) and apply directional linear thrust it is in the 12:45 to 11:15 positions, with a 12:00 average position accordingly. The exact opposite of the clockwise main rotor (15 or 39) and cancel each other's forces out for a smooth running system.

The angular velocity of the main rotors (15-39), orbital motors/generators (9-33) and the gyroscopes (19-43) are in nature, the total combined thrust capability from the AAMD.

Therefore, but not limited to: the greater the angular velocity of the main rotors (15-39), the greater the rotational simulated gravity is produced by means of the main rotors (15-39), as they are gravity multipliers. This increased rotational simulated gravity, produced by means of the main rotors (15-39), is applied to the orbital motors/generators (9-33) and the gyroscopes (19-43).

The greater the angular velocity of the orbital motors/generators (9-33), the greater the rotational simulated gravity is produced by means of the orbital motors/generators (9-33) as they are gravity multipliers as well. This increased rotational simulated gravity, produced by means of the orbital motors/generators (9-33), is applied to the gyroscopes (19-43).

The greater the rotational simulated gravity produced by means of the orbital motors/generators (9-33), the greater the rotational simulated gravity is applied to the gyroscopes (19-43). When the angular velocity of the orbital motors/generators (9-33), is high, the gyroscopes (19-43) experience the total of the rotational simulated gravity by means of the angular velocity of the orbital motors/generators (9-33), and they exhibit an increase in but not limited to: precessional, gyroscopic, centripetal and centrifugal forces.

This is due to the rotational simulated gravity by means of the orbital motors/generators (9-33), acting as there are ‘multiple gravitational forces’ applied to the gyroscopes (19-43). This increase on perceived rotational simulated gravity has the mass of the gyroscopes (19-43) be a factor of the increase in gravitational forces applied to the gyroscopes (19-43).

Therefore, but not limited to: if the gyroscopes (19-43) had a mass of 100 pounds and they were subjected to 2 times the gravity of earth by means of rotational simulated gravity, the perceived mass of the gyroscopes (19-43) in this environment would be 200 pounds. If a mass is subjected to a gyroscope is increased by twice, the precession angular velocity is increased by twice.

The same capability is produced by means of the rotational simulated gravity from the main rotors (15-39). As the central computers (25-49) monitors all forces in the system, the main rotors (15-39) applied rotational simulated gravity is also factored into the equation of the combined operation of the system. When combining all 8 orbital motors/generators (9-33) in each of the main rotors (15-39), produces a smooth continuous directional linear thrust system.

There are counter weights (52-53) that can but not limited to: connects with a counter weight (52-53) and can also be eliminated completely and use a direct connected linear motors for counter weights and gyroscopes (60), and any devise but not limited to: that controls the movement of the counter weights (52-53) by means of the central computers (25-49), for balanced main rotors (15-39).

Also monitor all gyroscopes (19-43) by means of the gyroscope positioning sensors (58) and the gyroscope positioning pickup (59). The central computers (25-49) also monitor all counter weights (52-53) by means of the counter weight positioning sensors (61) and the counter weight positioning pickup (62).

The counter weights (52-53) are precisely calibrated as to move in an inward direction towards the main rotors radius (4-28), as the gyroscopes (19-43) are moved in an outward direction away from the main rotors radius (4-28).

The linear motors for counter weights and gyroscopes (60) are powered by means of the capacitors/electrical energy source for linear motors for counter weights (65) and/or the large gyroscope motor/generator (16-40) and/or the rotor coils (7-31) and the main rotor stator coils (8-32).

The electrical power is controlled by means of the power controller for the main rotor stators (54-55) and controlled by means of the central computer (25-39) and move the counter weights (52-53) inward, to keep the main rotors (15-39) perfectly balanced when the gyroscopes (19-43) are moved to an outward direction away from the main rotors radius (4-28).

The force required to move the counter weights (52-53) outward, is but not limited to: equal to the force required to move the counter weights (52-53) inward by means of but not limited to: centrifugal forces and electrical input to the linear motors for counter weights and gyroscopes (60) to keep the main rotors (15-39) perfectly balanced.

When the gyroscopes (19-43) are moved in an inward direction towards the main rotors radius (4-28). Equal and opposite reaction on both side of the main rotors (15-39) cancel each other out.

The AAMD operates with Newtonian mechanics in reference to spinning gyroscopes and precessional effects of a torque on the angular momentum of the gyroscopes operating in 3 different spin directions and angular momentum vectors.

Since the mass around the main rotors (15-39) are completely equal and balanced. The produced centripetal and centrifugal forces by means of the main rotor (15-39) are exactly equal on both the 4 gyroscopes (19-43) and the counter weights (52-53). The main rotors (15-39) stay balanced and smooth turning without any pulsations.

On the clockwise rotating main rotor (15 or 39), when the orbital motors/generators (9-33) are but not limited to: rotating in the non precessional direction, position in the 6:00 location and they have no precessional torque.

On the clockwise rotating main rotor (15 or 39), when the orbital motors/generators (9-33) are but not limited to: rotating in the precessional direction, position in the 6:00 location and they are but not limited to: the angular momentum direction is that the location of the gyroscopes (19-43), produce torque by means of the precession forcing outward in the 6:00 direction.

There will be a torque produced in the 3:00 position during reducing angular velocity, dynamic braking, when the orbital motors/generators (9-33) are functioning as a generator and decrease their angular velocity.

There is a 12:00 directional linear thrust produced, as the gyroscopes (19-43) move their mass outward and moved the counter weights (52-53) mass inward by means of the Gyroscope pivot points (50-51) and the produced precessional torque from the gyroscopes (19-43).

The reduced angular velocity from the orbital motors/generators (9-33) enables the main rotors (15-39) rotational simulated gravity to overcome the orbital motors/generators (9-33) rotational simulated gravity placed on the gyroscopes (19-43).

Since all the mass around the main rotors (15-39) stayed equal and balanced, the torque produced to move the mass of the gyroscopes (19-43) and the counter weights (52-53) are completely equal, to and from the radius of the main rotors (15-39) and are cancelled out.

The produced but not limited to: precessional, gyroscopic, centripetal and centrifugal forces plus the linear motor for gyroscopes (63), move the gyroscopes (19-43) and the counter weights (52-53), move by means of the linear motor for gyroscopes (63).

Control means of the central computers (25-39) to produce directional linear thrust in the 12:00 position by means of the but not limited to: precessional, gyroscopic, centripetal and centrifugal forces plus the linear motor for gyroscopes (63), ‘squeezing’ the gyroscopes (19-43) together as they are extended in an outward direction away from the main rotors radius (15-39).

The ‘squeezing’ of the gyroscopes (19-43) together by means of the but not limited to: precessional, gyroscopic, centripetal, centrifugal forces by the gyroscopes (19-43) and the linear motor for gyroscopes (63), combined with their Gyroscope pivot points (50-51) operate as a first class lever.

When the gyroscopes (19-43) moves out away from the main rotors (15-39) axis of rotation, there is directional linear thrust produced to the main rotors shaft (4-28) in the opposite direction of the ‘squeezing force’ produced. The Gyroscope pivot points (50-51) are the fulcrum in between the gyroscopes (19-43) and the main rotors (15-39) axis.

If the gyroscopes (19-43) move but not limited to: and there was a 3 to 1 mechanical advantage and the gyroscopes (19-43) move in an outward direction from the main rotors (15-39) radius by of 6″, the produced ‘squeezing force’ produced will apply a 2″ direction linear force towards the main rotors (15-39).

Naturally occurring axis of rotation (4-28) and this directional linear thrust will be in the exact opposite direction of the movement of the gyroscopes (19-43) moving in an outward direction away from the main rotors (15-39) radius.

The actual linear movement of the main rotors (15-39) naturally occurring axis of rotation in the direction opposite of the movement of the gyroscopes (19-43) moving in an outward direction will be a factor of the mass of the entire vehicle and the amount of but not limited to: the linear motor for gyroscopes (63), precessional, gyroscopic, centripetal and centrifugal forces applied by means of the gyroscopes (19-43).

The gyroscopes (19-43) that are applying the ‘squeezing force’ to the Gyroscope pivot points (50-51) are in the exact opposite location around the orbital motors/generators (9-33) axis of rotation. This enables the torqueing action between the gyroscopes (19-43) to be canceled out.

On the counter clockwise rotating main rotor (15 or 39), when the orbital motors/generators (9-33) are but not limited to: rotating in the non precessional direction, position in the 6:00 average location and they have no precessional torque.

On the counter clockwise rotating main rotor (15 or 39), when the orbital motors/generators (9-33) are but not limited to: rotating in the precessional direction, position in the 6:00 average location and they are but not limited to: the angular momentum direction is that the location of the gyroscopes (19-43), produce torque by means of the precession forcing outward in the 6:00 average direction.

There will be a torque produced in the 9:00 or 3:00 average position during reducing angular velocity, dynamic braking, depending on the direction of rotation of the orbital motors/generators (9-33) when they are functioning as a generator and decrease their angular velocity.

There is a 12:00 average directional linear thrust produced, as the gyroscopes (19-43) move their mass outward by means of the linear motor for gyroscopes (63), Gyroscope pivot points (50-51) and moved the counter weights (52-53) mass inward by means of the linear motors for counter weight (60).

The directional linear thrust is by means of the gyroscopes (19-43) being ‘forced’ outward, away from the main rotors (15-39) axis, by means of but not limited to: plus the linear motor for gyroscopes (63), precessional, gyroscopic, centripetal and centrifugal forces applied by means of the gyroscopes (19-43).

The reduced angular velocity from the orbital motors/generators (9-33) enables the main rotors (15-39) rotational simulated gravity to overcome the orbital motors/generators (9-33) rotational simulated gravity placed on the gyroscopes (19-43).

Since all the mass around the main rotors (15-39) stayed equal and balanced, the torque produced to move the mass of the gyroscopes (19-43) and the counter weights (52-53) are completely equal, to and from the radius of the main rotors (15-39) and are cancelled out.

On the other side of the clockwise rotating main rotor (15 or 39), when the orbital motors/generators (9-33) position in the 12:00 average location and they are but not limited to: rotating in the clockwise rotation and functioning as a motor, the linear motor for gyroscopes (63), precessional, gyroscopic, centripetal and centrifugal forces applied by means of the gyroscopes (19-43) forcing outward in the 12:00 average direction.

Then there will be a torque produced in the 9:00 or 3:00 average position, applied to the main shafts (4-28), depending on the direction of rotation of the orbital motors/generators (9-33), during the increasing angular velocity, when the orbital motors/generators (9-33) are functioning as a motor. There is a 12:00 average directional linear thrusts produced, as the orbital motors/generators function as a motor and increase their angular velocity.

The gyroscopes (19-43) will increase angular velocity and with assistance by means of the linear motor for gyroscopes (63), begin to increase their diameter as their mass is moved outward in diameter, by means of the Gyroscope pivot points (50-51) and the gyroscopes are moved closer to the main rotors (15-39) axis.

At the same time, the counter weights (52-53) are moved outward, away from the main rotors (15-39) axis by means of the linear motor for counter weights (60) and control means of the central computers (25-49) and the centripetal and centrifugal forces applied by means of the main rotors (15-39).

The increased angular velocity from the orbital motors/generators (9-33) enables the orbital motors/generators (9-33) rotational simulated gravity placed on the gyroscopes (19-43) to overcome the rotational simulated gravity from the main rotors (15-39).

Since all the mass around the main rotors (15-39) stayed equal and balanced, the torque produced to move the mass the counter weights (52-53) in towards and away from the main rotors (15-39) axis, are completely equal and are cancelled out.

On the other side of the counter clockwise rotating main rotor (15 or 39), when the orbital motors/generators (9-33) position in the 12:00 average location and they are but not limited to: rotating in the clockwise rotation and functioning as a motor, the linear motor for gyroscopes (63), precessional, gyroscopic, centripetal and centrifugal forces applied by means of the gyroscopes (19-43) forcing outward in the 12:00 direction.

Then there will be a torque produced in the 9:00 or 3:00 average position, applied to the main shafts (4-28), depending on the direction of rotation of the orbital motors/generators (9-33), during the increasing angular velocity, when the orbital motors/generators (9-33) are functioning as a motor. There is a 12:00 average directional linear thrusts produced, as the orbital motors/generators (9-33) function as a motor and increase their angular velocity.

The gyroscopes (19-43) will increase angular velocity and begin to increase their diameter as their mass is moved inward by means of the linear motor for gyroscopes (63) and Gyroscope pivot points (50-51) and the counter weights (52-53) mass moves outward by means of the linear motors for counter weight (60) and the centripetal and centrifugal forces applied by means of the main rotors (15-39).

The increased angular velocity from the orbital motors/generators (9-33) enables the orbital motors/generators (9-33) rotational simulated gravity placed on the gyroscopes (19-43) to overcome the rotational simulated gravity from the main rotors (15-39).

Since all the mass around the main rotors (15-39) stayed equal and balanced, the torque produced to move the mass the counter weights (52-53) in towards and away from the main rotors (15-39) axis, are completely equal and are cancelled out.

The manner in manipulating, controlling the 3 different spin directions and angular momentum vectors that enable the AAMD to produce a controllable directional linear thrust by means of the gyroscopes (19-43). The central computers (25-49) can but not limited to: direct the propulsion system in any of the 360 degrees all around the vehicle, but not limited to: within one degree.

The central computers (25-49) can enable the main rotors (15-39), orbital motors/generators (9-33) and gyroscopes (19-43) to rotate in any direction independent to each other. The central computers (25-49) can enable the main rotors (15-39), orbital motors/generators (9-33) and gyroscopes (19-43) to rotate in any angular velocity independent to each other.

The means of using the resistive force by means of quickly shifting and resetting the gyroscopes position, within the 3 angular momentum vectors and provides directional linear thrust by the “rapid movement of the gyroscopes” changing position, explained in the “push”-“pull” procedure and does not violate Newton's third law, as the counter force is 90 degrees from the directional linear thrust and they are cancelled out due to the 2 counter rotating main rotors (15-39).

“For every action, there is an equal and opposite reaction.”

Therefore, if the power source was but not limited to: a nuclear reactor, the distance a space ship equipped with the AAMD can travel would be very beneficial, compared to a rocket propulsion system.

### Operation of the Altitude Control System

The altitude control system within the AAMD enables the vehicle to not only have directional linear thrust capabilities but also provide the vehicle a flight control system to allow the vehicle to fly through space without interacting with an outside medium.

There are but not limited to: 4-180 degree altitude control stator coils (10-34) and 4 altitude control magnets (13-37). The altitude control magnets (13-37) are held in place with but not limited to: a magnetic bearing system (14-38) and are connected to the main rotors (15-39) and are placed between the orbital motors/generators (9-33).

The altitude control magnets (13-37) are held in in proper alignment with the altitude control coils (10-34) by means of permanent magnets connected to rotors (11-35) and the permanent magnets connected to altitude control magnets (12-36). The altitude control coils (10-34) can function as a generator or a motor by means of the central computers (25-49).

When the altitude control magnets (13-37) pass the 12:00 position spinning clockwise, the central computers (25-49) that controls the altitude control system informs the top 180 degree altitude control coils (19-34) to function like a motor.

The magnetic induction attempt's to pull the altitude control magnets (13-37) clockwise, also pulling the altitude control magnets (13-37) up slightly off the centerline of the main rotors (15-39); producing a “downward” force to the top 180 degree altitude control coils (19-34) from the 12:00 to 6:00 centered at the 3:00 position.

The electrical input to the top 180 degree altitude control coils (19-34) functioning as a motor, comes from the electrical output from the bottom top 180 degree altitude control coils (19-34) that functions as a generator. This happen over and over when the altitude control magnets (13-37) pass the 12:00 to 6:00 centered at the 3:00 position spinning clockwise.

The bottom 180 degree altitude control coils (19-34) functioning as a generator.

The magnetic induction attempt's to push the altitude control magnets (13-37) counter clockwise, also pushing the altitude control magnets (13-37) up slightly off the centerline of the main rotors (15-39), giving a “downward” force to the bottom 180 degree altitude control coils (19-34) from 12:00 to 6:00 centered at the 3:00 position producing electrical output.

When the altitude control magnets (13-37) pass the 12:00 position spinning counter clockwise, the central computers (25-49) that controls the altitude control system informs the top 180 degree altitude control coils (19-34) to function like a motor.

The magnetic induction attempt's to pull the altitude control magnets (13-37) clockwise, also pulling the altitude control magnets (13-37) up slightly off the centerline of the main rotors (15-39); producing a “downward” force to the top 180 degree altitude control coils (19-34) from the 6:00 to 12:00 centered at the 3:00 position.

The electrical input to the top 180 degree altitude control coils (19-34) functioning as a motor, comes from the electrical output from the bottom top 180 degree altitude control coils (19-34) that functions as a generator. This happen over and over when the altitude control magnets (13-37) pass the 6:00 to 12:00 centered at the 3:00 position spinning counter clockwise.

The bottom 180 degree altitude control coils (19-34) functioning as a generator. The magnetic induction attempt's to push the altitude control magnets (13-37) counter clockwise, also pushing the altitude control magnets (13-37) up slightly off the centerline of the main rotors (15-39), giving a “downward” force to the bottom 180 degree altitude control coils (19-34) from 6:00 to 12:00 centered at the 3:00 position producing electrical output.

This method can be calculated in any of the 360 degrees around the AAMD by means of the central computers (25-39) and provide a calculated twisting action to the system. There are propulsion director motors (24-48) that are controlled by means of the central computers (25-49) to assist in the directional linear thrust in an up and down manner and not just straight line directional linear thrust.

The altitude control system can also assist the AAMD in the maneuvering by providing a twisting action on the vehicle in a calculated manner by means of the central computers (25-49). The central computers can but not limited to: direct the altitude control system in any of the 360 degrees all around the vehicle within one degree.

There are propulsion director motors (24-48) that can further increase the maneuverability of the AAMD, by means of moving all propulsion director motors (24-48) independently from each other, by means of the central computers (24-49). The central computers can but not limited to: direct the propulsion director motors (24-48) in any of the 360 degrees all around the vehicle within one degree.

What is claimed is:

1. An internal propulsion apparatus converting rotational motion into directional linear thrust, comprising:
a. two or more Main rotors (15-39)
b. two or more Rotor motors/generators (5-6-29-30)
c. two or more Orbital motors/generators (9-33), with its axis positioned but not limited to: 90 degrees separate from the axis of said Main rotors (15-39)
d. two or more Gyroscope motors/generators (18-42) with two or more gyroscopes (19-43), with its axis positioned but not limited to: 90 degrees separate from the axis of said Orbital motors/generators (9-33)
e. Electrical input (67) to power said Rotor motors/generators (5-6-29-30)
f. a Computer control system (25-49), for control means of all said components

2. An internal propulsion apparatus as claimed in claim 1, further comprises:
a. one or more Main shafts (4-28)
b. one or more bearing system (3-27)
c. one or more sensing means (22-23-46-47) to provide rotational velocity of said Main rotors (15-39)
d. one or more Rotor motors/generators (7-8-31-32)
e. one or more power controllers for the main rotor stators (54-55)

3. An internal propulsion apparatus as claimed in claim 1, further comprises:
a. Main base (1)
b. one or more outer case (2-26)
c. one or more Altitude control (13-37-10-34)
d. one or more Propulsion directors (24-48)
e. one or more Main power control (56)
f. one or more bearings system (14-38)
g. one or more large gyroscope motor/generator (16-40)
h. one or more orbital motor/generator, gyroscope assembly connector (17-41)

4. An internal propulsion apparatus as claimed in claim 1, further comprises:
A Gyroscope assembly (66), with but not limited to: linear motor for gyroscopes and counter weights, comprising,
a. Small gyroscope motors/generators (18-42)
b. said Gyroscopes (19-43)
c. Gyroscope pivot points (50-51)
d. Counter weights (52-53)
e. Linear motor for gyroscopes (63)
f. Gyroscopes and counter weights positioning sensors and pickups (58-59)
g. Linear motors for counter weights and gyroscopes (60)

5. An internal propulsion apparatus as claimed in claim 1, further comprises:
A Gyroscope assembly (66), with but not limited to: linkage for gyroscopes and counter weights, comprising,
a. Gyroscope motors/generators (18-42)
b. said Gyroscopes (19-43)
c. Gyroscope pivot points (50-51)
d. Counter weights (52-53)
e. Linear motor for counter weights and gyroscopes (60)
f. Counter weight (52-53)
g. Counter weight and gyroscope positioning sensors and pickups (61-62)

6. An internal propulsion apparatus converting rotational motion into directional linear thrust, comprising:
a. 2 or more electric motor powered, counter rotating Main rotors (15-39)
b. 2 or more Orbital motors/generators (9-33), positioned near the outer section, further away from radius of said Main rotors (15-39), with its axis positioned but not limited to: 90 degrees separate from the axis of said Main rotors (15-39)
c. 2 or more electric motor powered, Gyroscopes (19-43) positioned near the outer section away from said Orbital motors/generators (9-33), and further away from radius of Main rotors (15-39), with its axis positioned but not limited to: 90 degrees separate from the axis of said Orbital motors/generators (9-33)
d. 2 or more electric motor powered, Counter weights (52-53) positioned near the outer section away from said Orbital motors/generators (9-33), and away from radius of Main rotors (15-39)
e. Electrical input (67) to power said Rotor motors/generators (5-6-29-30)
f. a Computer control system (25-49), for control means of all said components

7. An internal propulsion apparatus as claimed in claim 6, further comprises:
a. one or more Main shafts (4-28)
b. one or more bearing system (3-27)
c. one or more sensing means (22-23-46-47) to provide rotational velocity of said Main rotors (15-39).
d. one or more Rotor motors/generators (7-8-31-32)
e. one or more power controllers for the main rotor stators (54-55)

8. An internal propulsion apparatus as claimed in claim 6, further comprises:
a. Main base (1)
b. one or more outer case (2-26)
c. one or more Altitude control (13-37-10-34)
d. one or more Propulsion directors (24-48)
e. one or more Main power control (56)
f. one or more bearings system (14-38)
g. one or more large gyroscope motor/generator (16-40)
h. one or more orbital motor/generator, gyroscope assembly connector (17-41)

9. An internal propulsion apparatus as claimed in claim 6, further comprises:
A Gyroscope assembly (66), with but not limited to: linear motor for gyroscopes and counter weights comprising,
a. Small gyroscope motors/generators (18-42)
b. said Gyroscopes (19-43)
c. Gyroscope pivot points (50-51)
d. Counter weights (52-53)
e. Linear motor for gyroscopes (63)
f. Gyroscopes and counter weights positioning sensors and pickups (58-59)
g. Linear motors for counter weights and gyroscopes (60)

10. An internal propulsion apparatus as claimed in claim 6, further comprises:
A Gyroscope assembly (66), with but not limited to: linkage for gyroscopes and counter weights, comprising,
a. Gyroscope motors/generators (18-42)
b. said Gyroscopes (19-43)
c. Gyroscope pivot points (50-51)
d. Counter weights (52-53)
e. Linear motor for counter weights and gyroscopes (60)
f. Counter weight (52-53)
g. Counter weight and gyroscope positioning sensors and pickups (61-62)
